(19) United States
(12) Patent Application Publication
(10) Pub. No.: US 2026/0186574 A1
(43) Pub. Date: Jul. 2, 2026

(54) VIBRATION APPARATUS, DISPLAY APPARATUS AND VEHICULAR APPARATUS COMPRISING THE SAME

(71) Applicant: LG Display Co., Ltd., Seoul (KR)

(72) Inventors: Seunghyun SUNG, Paju-si (KR); YuSeon KHO, Paju-si (KR); SeungRyull PARK, Paju-si (KR)

(73) Assignee: LG Display Co., Ltd., Seoul (KR)

(21) Appl. No.: 19/402,027

(22) Filed: Nov. 26, 2025

(30) Foreign Application Priority Data
Dec. 31, 2024 (KR) 10-2024-0202312

(51) Int. Cl. G06F 3/01; B60K 35/10; B60K 35/22; B60K 35/25; G06F 3/041

(52) U.S. Cl. CPC G06F 3/016; B60K 35/10; B60K 35/22; B60K 35/25; B60K 2360/143; G06F 3/041

(57) ABSTRACT

A vibration apparatus, and a display apparatus and a vehicular apparatus including the same are disclosed. A vibration apparatus according to one or more embodiments of the present disclosure comprises first to n-th (where n is a natural number greater than or equal to 3) vibration parts disposed parallel to each other, a first cover member covering a first surface of each of the first to n-th vibration parts, a second cover member covering a second surface opposite to the first surface of each of the first to n-th vibration parts, and an adhesive member disposed between the first cover member and the second cover member and surrounding side surfaces of each of the first to n-th vibration parts. Each of the first to n-th vibration parts comprises any one shape of a circular plate shape, an oval plate shape, and a polygonal plate shape.

### CROSS-REFERENCE TO RELATED APPLICATION

This application claims the benefit of and priority to Korean Patent Application No. 10-2024-0202312 filed on Dec. 31, 2024, the entirety of which is hereby incorporated by reference for all purposes as if fully set forth herein.

### BACKGROUND

### Technical Field

The present disclosure relates to a vibration apparatus, and a display apparatus and a vehicular apparatus including the same.

### Description of the Related Art

As information-oriented society advances, the needs for display apparatuses displaying an image are variously increasing.

Electronic devices using a display apparatus as a display screen provide a user interface of a touch screen type, for convenience of a user input. Display apparatuses capable of touch interface processing are advancing to provide more various functions.

Recently, haptic technology, which provides a haptic feedback to a user when the user touches a screen of a display apparatus, is being developed. Display apparatuses to which the haptic technology is applied generate a stimulating force for stimulating a tangoreceptor of a human body, and stimulate a tactile sense of a user by using the stimulating force, thereby enabling the user to recognize a touch and a texture of the touch.

Haptic feedback may be implemented by a haptic module such as a voice coil motor (VCM) or a linear resonance actuator (LRA). Such a haptic module is heavy and rigid, making them difficult to flexibly and thinly, and are designed to operate only at specific frequencies, limiting their ability to implement tactile feedback of various textures.

### BRIEF SUMMARY

The inventors of the present disclosure have recognized the above-mentioned problems and have continuously conducted various researches and experiments on a vibration apparatus that may be driven at various frequencies and may output one or more of sound and haptic feedback of various textures. Based on the various researches and experiments, the inventors of the present disclosure have invented a vibration apparatus that may be driven at various frequencies and may implement tactile feedbacks of various textures, and a display apparatus and a vehicular apparatus including the same.

One or more aspects of the present disclosure are directed to providing a vibration apparatus capable of being driven at various frequencies and outputting one or more of sound and haptic feedback of various textures, and a display apparatus and a vehicular apparatus including the same.

One or more aspects of the present disclosure are directed to providing a vibration apparatus capable of being flexible and thinned and outputting one or more of sound and haptic feedback of various textures, and a display apparatus and a vehicular apparatus including the same.

Additional features, advantages, and aspects of the present disclosure are set forth in part in the present disclosure and will also be apparent from the present disclosure or may be learned by practice of the inventive concepts provided herein. Other features, advantages, and aspects of the present disclosure may be realized and attained by the descriptions provided in the present disclosure, or derivable therefrom, and claims hereof as well as the appended drawings.

To achieve these and other advantages and aspects of the present disclosure, as embodied and broadly described herein, in one or more aspects, a vibration apparatus comprises first to n-th (where n is a natural number greater than or equal to 3) vibration parts disposed parallel to each other, a first cover member covering a first surface of each of the first to n-th vibration parts, a second cover member covering a second surface opposite to the first surface of each of the first to n-th vibration parts, and an adhesive member disposed between the first cover member and the second cover member and surrounding side surfaces of each of the first to n-th vibration parts. Each of the first to n-th vibration parts comprises any one shape of a circular plate shape, an oval plate shape, and a polygonal plate shape.

In the vibration apparatus according to one or more embodiments of the present disclosure, some of the first to n-th vibration parts have a different size.

In the vibration apparatus according to one or more embodiments of the present disclosure, each of the first to n-th vibration parts outputs any one of a sound, a directional sound, a vibration haptic, and an ultrasonic haptic.

A display apparatus according to one or more embodiments of the present disclosure comprises a display panel configured to display an image, and one or more vibration generating apparatuses attached to a rear surface of the display panel. The one or more vibration generating apparatuses comprise a vibration apparatus. The vibration apparatus comprises first to n-th (where n is a natural number greater than or equal to 3) vibration parts disposed parallel to each other, a first cover member covering a first surface of each of the first to n-th vibration parts, a second cover member covering a second surface opposite to the first surface of each of the first to n-th vibration parts, and an adhesive member disposed between the first cover member and the second cover member and surrounding side surfaces of each of the first to n-th vibration parts. Each of the first to n-th vibration parts comprises any one shape of a circular plate shape, an oval plate shape, and a polygonal plate shape.

A vehicular apparatus according to one or more embodiments of the present disclosure comprises a dashboard including a first region facing a driver seat, a second region facing a passenger seat, and a third region between the first region and the second region; an instrument panel module including a first display disposed at the dashboard; a central control module including a second display extending from the third region of the dashboard into a space between the driver seat and the passenger seat; and an infotainment module including at least one of a third display disposed at a rear surface of the driver seat and a fourth display disposed at a rear surface of the passenger seat. One or more of the first to fourth displays comprises a display panel configured to display an image, and one or more vibration generating apparatuses attached to a rear surface of the display panel. The one or more vibration generating apparatuses comprise a vibration apparatus. The vibration apparatus comprises first to n-th (where n is a natural number greater than or equal to 3) vibration parts disposed parallel to each other, a first cover member covering a first surface of each of the first to n-th vibration parts, a second cover member covering a second surface opposite to the first surface of each of the first to n-th vibration parts, and an adhesive member disposed between the first cover member and the second cover member and surrounding side surfaces of each of the first to n-th vibration parts. Each of the first to n-th vibration parts comprises any one shape of a circular plate shape, an oval plate shape, and a polygonal plate shape.

A vehicular apparatus according to one or more embodiments of the present disclosure comprises a vehicle interior material including a steering wheel, a room mirror, and a door interior material; a dashboard including a first region facing a driver seat, a second region facing a passenger seat, and a third region between the first region and the second region; an instrument panel module including a main display extending from the first region of the dashboard into the third region or the second region; a central control module including a second display extending from the third region of the dashboard into a space between the driver seat and the passenger seat; and a smart surface display disposed at one or more of the steering wheel, the room mirror, and the door interior material. One or more of the main display and the smart surface display comprises a display panel configured to display an image, and
one or more vibration generating apparatuses attached to a rear surface of the display panel. The one or more vibration generating apparatuses comprise a vibration apparatus. The vibration apparatus comprises first to n-th (where n is a natural number greater than or equal to 3) vibration parts disposed parallel to each other, a first cover member covering a first surface of each of the first to n-th vibration parts, a second cover member covering a second surface opposite to the first surface of each of the first to n-th vibration parts, and an adhesive member disposed between the first cover member and the second cover member and surrounding side surfaces of each of the first to n-th vibration parts. Each of the first to n-th vibration parts comprises any one shape of a circular plate shape, an oval plate shape, and a polygonal plate shape.

Details of other exemplary embodiments will be included in the detailed description of the disclosure and the accompanying drawings.

One or more embodiments of the present disclosure may provide a vibration apparatus capable of being driven at various frequencies and outputting one or more of sound and haptic feedback of various textures, and a display apparatus and a vehicular apparatus including the same.

One or more embodiments of the present disclosure may provide a vibration apparatus capable of being flexible and thinned and outputting one or more of sound and haptic feedback of various textures, and a display apparatus and a vehicular apparatus including the same.

According to one or more embodiments of the present disclosure, a plurality of vibration parts, a first cover member, and a second cover member are configured or structured as one vibration apparatus having a film form integrated with each other, and thus, ESG (environmental, social, and governance) may be implemented due to the effect of uni-materialization.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing description and the following description of the present disclosure are exemplary and explanatory and are intended to provide further explanation of the disclosure as claimed.

### BRIEF DESCRIPTION OF THE SEVERAL VIEWS OF THE DRAWINGS

The accompanying drawings, which are included to provide a further understanding of the disclosure, are incorporated in and constitute a part of the present disclosure, illustrate aspects and embodiments of the disclosure and together with the description serve to explain principles of the disclosure. However, the technical features of the present embodiment are not limited to those shown in the specific drawings, and the features disclosed in each drawing may be combined to form a new embodiment.

FIG. 1 is a plan view of a vibration apparatus according to a first embodiment of the present disclosure.

FIG. 2 is a cross-sectional view taken along line I-I′ illustrated in FIG. 1.

FIG. 3 is an exploded perspective view of a vibration apparatus according to a first embodiment of the present disclosure.

FIG. 4 is a plan view illustrating a vibration apparatus according to a second embodiment of the present disclosure.

FIG. 5 is another plan view illustrating a vibration apparatus according to a second embodiment of the present disclosure.

FIG. 6 is a plan view illustrating a vibration apparatus according to a third embodiment of the present disclosure.

FIG. 7 is a plan view illustrating a vibration apparatus according to a fourth embodiment of the present disclosure.

FIG. 8 is a waveform diagram illustrating a texture haptic signal according to an embodiment of the present disclosure.

FIG. 9 is a cross-sectional view illustrating a display apparatus according to a first embodiment of the present disclosure.

FIG. 10 is a cross-sectional view illustrating a display apparatus according to a second embodiment of the present disclosure.

FIGS. 11A to 11N are diagrams illustrating a sound output and a haptic output of the display apparatus according to the first and second embodiments of the present disclosure illustrated in FIGS. 9 and 10.

FIG. 12 is a diagram illustrating a vehicular apparatus according to an embodiment of the present disclosure.

FIG. 13 is a plan view illustrating a vehicular apparatus according to an embodiment of the present disclosure.

FIG. 14 is a diagram illustrating a first display illustrated in FIGS. 12 and 13.

Throughout the drawings and the detailed description, unless otherwise described, the same drawing reference numerals should be understood to refer to the same elements, features, and structures. The sizes, lengths, and thicknesses of layers, regions and elements, and depiction of thereof may be exaggerated for clarity, illustration, and convenience.

### DETAILED DESCRIPTION

Advantages and features of the present disclosure, and implementation methods thereof, are clarified through the aspects described with reference to the accompanying drawings. The present disclosure may, however, be embodied in different forms and should not be construed as limited to the example aspects set forth herein. Rather, these example aspects are examples and are provided so that this disclosure may be thorough and complete to assist those skilled in the art to understand the inventive concepts without limiting the protected scope of the present disclosure.

A shape, a size, a ratio, an angle, and a number disclosed in the drawings for describing embodiments of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present disclosure are used, another part may be added unless “only” is used. The terms of a singular form may include plural forms unless referred to the contrary.

In construing an element, the element is construed as including an error range although there is no explicit description.

In describing a position relationship, for example, when a position relation between two parts is described as “on”, “over”, “under”, “next”, and “adjacent to” or the like, one or more other parts may be located between the two parts unless a more limiting term, such as “immediate(ly)”, “direct(ly)”, or “close(ly)” is used.

For the expression that an element is “connected”, “coupled”, or “attach” to another element, the element may not only be directly connected, coupled, or contacted to another element, but also be indirectly connected, coupled, or attached to another element with one or more intervening elements interposed between the elements, unless otherwise specified.

For the expression that an element is “overlaps” with another element, the element can not only directly contact, overlap, or the like with another element, but also indirectly overlap with another element with one or more intervening elements disposed or interposed between the elements, unless otherwise specified.

“a first direction”, “a second direction”, “a third direction”, “X-axis direction”, “Y-axis direction”, and “Z-axis direction” should not be construed by a geometric relation only of a mutual vertical relation and may have broader directionality within the range that elements of the present disclosure may act functionally.

Features of various embodiments of the present disclosure may be partially or overall coupled to or combined with each other and may be variously inter-operated with each other and driven technically as those skilled in the art can sufficiently understand. The embodiments of the present disclosure may be carried out independently from each other or may be carried out together in co-dependent relationship.

Hereinafter, example embodiments of a vibration apparatus according to the present disclosure will be described in detail with reference to the accompanying drawings. For convenience of description, a scale of each of elements illustrated in the accompanying drawings differs from a real scale, and thus, is not limited to a scale illustrated in the drawings.

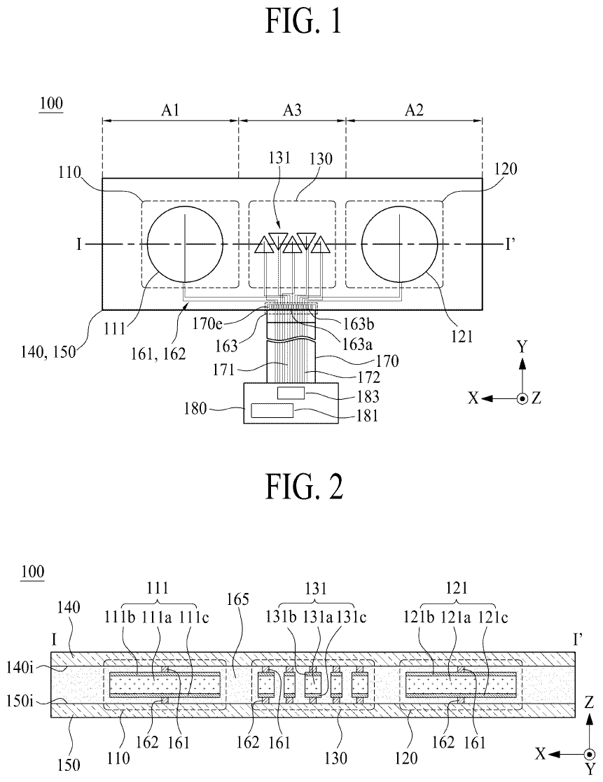

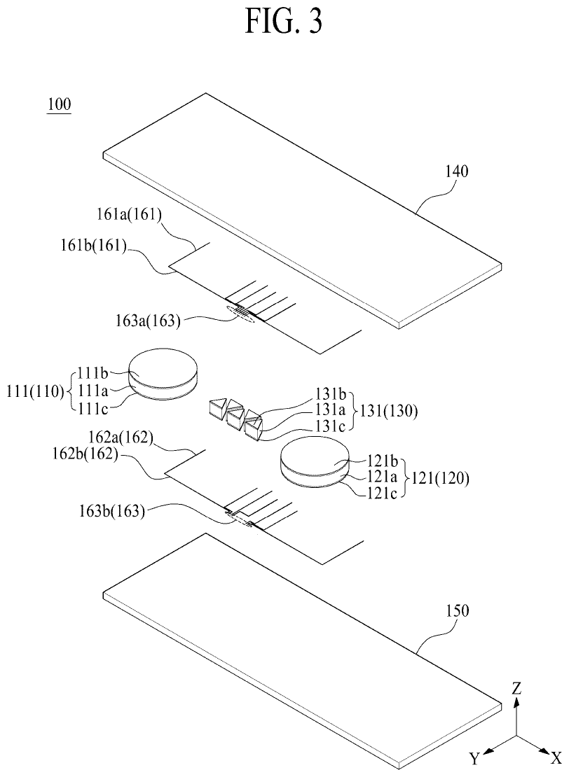

FIG. 1 is a plan view of a vibration apparatus according to a first embodiment of the present disclosure. FIG. 2 is a cross-sectional view taken along line I-I′ illustrated in FIG. 1. FIG. 3 is an exploded perspective view of a vibration apparatus according to a first embodiment of the present disclosure.

Referring to FIGS. 1 to 3, a vibration apparatus 100 according to a first embodiment of the present disclosure may be configured or structured to output one or more of a sound, a directional sound, a vibration haptic, a texture haptic, and an ultrasonic haptic. For example, the vibration apparatus 100 may be configured or structured to output one of the sound, the directional sound, the vibration haptic, the texture haptic, and the ultrasonic haptic, or to simultaneously output two or three of them. Accordingly, the vibration apparatus 100 according to the first embodiment of the present disclosure may be expressed as a vibration film, an actuator, a transducer, a flexible vibration film, a flexible vibration apparatus, a flexible actuator, a flexible piezoelectric speaker, a film actuator, a sound/haptic apparatus, a sound/haptic actuator, a film-type sound/haptic actuator, or a multi-textured haptic apparatus, but is not limited thereto.

The vibration apparatus 100 according to the first embodiment of the present disclosure may include first, second, third vibration parts 110, 120, 130 to n-th vibration part (where n is a natural number greater than or equal to 3, and in the case of n being 3, the third vibration part 130 to n-th vibration part refers to the third vibration part 130), a first cover member 140, and a second cover member 150.

The first, second, third vibration parts 110, 120, 130 to n-th vibration part may be disposed (or configured) parallel to each other. For example, the first, second, third vibration parts 110, 120, 130 to n-th vibration part may be disposed along a first direction X (or X-axis direction) at a predetermined interval. For example, the first direction X (or X-axis direction) may be parallel to a long-side length direction of the vibration apparatus 100, but is not limited thereto.

Some of the first, second, third vibration parts 110, 120, 130 to n-th vibration part may have a different size or a different shape. For example, some of the first, second, third vibration parts 110, 120, 130 to n-th vibration part may have a smaller size than the others, or some of the first, second, third vibration parts 110, 120, 130 to n-th vibration part may have a shape or a size different from the others. For example, each of the first, second, third vibration parts 110, 120, 130 to n-th vibration part may comprise any one shape of a circular plate shape, an oval plate shape, and a polygonal plate shape. For example, each of the first, second, third vibration parts 110, 120, 130 to n-th vibration part may comprise any one shape of a circular plate shape, an oval plate shape, a square plate shape, and a triangular plate shape. Accordingly, some of the first, second, third vibration parts 110, 120, 130 to n-th vibration part have different sizes, and thus, each of the first, second, third vibration parts 110, 120, 130 to n-th vibration part may be configured or structured to output any one of a sound, a directional sound, a vibration haptics, a texture haptic, and an ultrasonic haptic. The first, second, third vibration parts 110, 120, 130 to n-th vibration part may be configured or structured to output one of the sound, the directional sound, the vibration haptic, the texture haptic, or the ultrasonic haptic, or to simultaneously output two or three of them.

The vibration apparatus 100 according to the first embodiment of the present disclosure may include a rectangular shape having a long side and a short side, and may include first to third areas A1, A2, and A3.

The first to third areas A1, A2, and A3 may be disposed parallel to each other. For example, the third area A3 may be disposed between the first area A1 and the second area A2. For example, the first area A1 and the second area A2 may be disposed parallel to each other with the third area A3 therebetween.

The third area A3 may include a central portion of the vibration apparatus 100. For example, the third area A3 may include a central portion in the long-side length direction of the vibration apparatus 100. The third area A3 may be disposed between the first area A1 and the second area A2.

The first area A1 may include a portion between a first short side of the vibration apparatus 100 and the third area A3. For example, the first area A1 may include one side portion (or a left side portion) of the third area A3 or a first edge portion of the vibration apparatus 100.

The second area A2 may include a portion between a second short side of the vibration apparatus 100 and the third area A3. For example, the second area A2 may include the other side portion (or a right side portion) of the third area A3 or a second edge portion of the vibration apparatus 100.

The first vibration part 110 may be disposed at the first area A1, the second vibration part 120 may be disposed at the second area A2, and the third vibration part 130 may be disposed at the third area A3.

The first vibration part 110 may include one or more first vibration devices 111. For example, the first vibration part 110 may include one first vibration device (or a single first vibration device) 111 having the circular plate shape.

The second vibration part 120 may include one or more second vibration devices 121. For example, the second vibration part 120 may include one second vibration device (or a single second vibration device) 121 having the circular plate shape. For example, the one second vibration device 121 may have a same shape and a size as the one first vibration device 111.

The third vibration part 130 may include a plurality of third vibration devices 131.

The plurality of third vibration devices 131 according to an embodiment may be spaced apart from each other along one or more of the first direction X and a second direction Y. For example, the third vibration part 130 may be disposed in a line (or a row) to have a predetermined interval along the first direction X (or X-axis direction).

The plurality of third vibration devices 131 according to another embodiment may be disposed in a line (or a row) without intervals. For example, when the plurality of third vibration devices 131 are disposed in a side contact manner without an interval (or a gap), the plurality of third vibration devices 131 may have a same vibration (or displacement) characteristic as one vibration device (or a single vibration device) having a same size.

Each of the plurality of third vibration devices 131 may have a triangular plate shape. The third vibration part 130 may include the plurality of third vibration devices 131 having an equilateral triangular plate shape. Each of the plurality of third vibration devices 131 may include a triangular plate shape having a same size (or a same area). The plurality of third vibration devices 131 having the triangular shape may be disposed along the first direction X (or X-axis direction) with a predetermined interval or without an interval (or a gap). For example, the third vibration part 130 may include five third vibration devices 131. For example, the plurality of third vibration devices 131 may be disposed to form a trapezoidal shape in a plan view, but are not limited thereto. Accordingly, the third vibration part 130 may include a trapezoidal shape in a plan view, but is not limited thereto. The plurality of third vibration devices 131 may be disposed to form an oval plate shape in a plan view. For example, the third vibration part 130 may include two or more third vibration devices 131 having the triangular plate shape, and the two or more third vibration devices 131 may be disposed adjacent to form a polygonal shape having 2M (where M is a natural number greater than or equal to 2) sides. For example, the polygonal shape may include a parallelogram, a rectangle, a trapezoid, a hexagon, an octagon, or a decagon, or the like, in a plan view.

A total size (or area) of the plurality of third vibration devices 131 may be smaller than the size (or area) of each of the one first vibration device 111 and the one second vibration device 121.

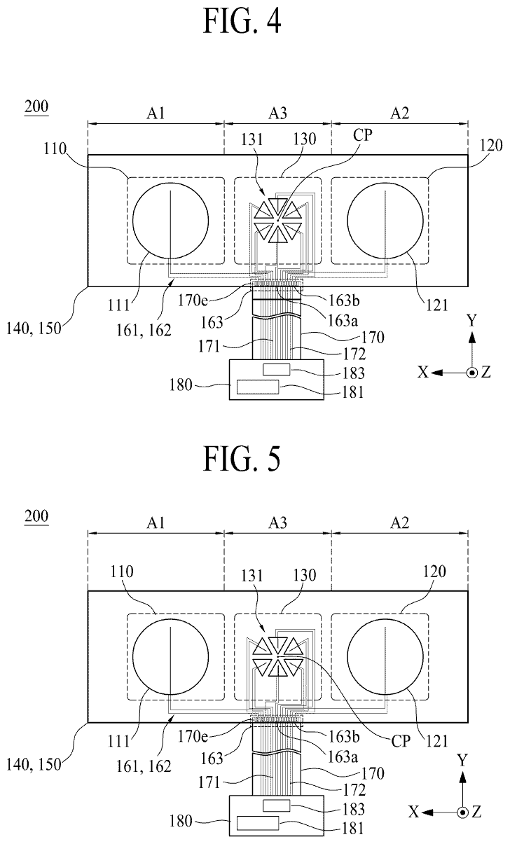

The one first vibration device 111 and the one second vibration device 121 may have a symmetrical (or a horizontal or left-right symmetric) structure with respect to a center portion CP (see FIG. 4) of the third area A3 (or vibration apparatus 100), and the plurality of third vibration devices 131 may have both vertical and horizontal (or upper-lower and left-right) symmetrical structures with respect to the center portion CP of the third area A3.

According to an embodiment, a sound characteristic and/or a sound pressure level characteristic of a low-pitched sound band may improve as the size of the vibration devices 111, 121 and 131 increases, and a sound characteristic and/or a sound pressure level characteristic of a high-pitched sound band may improve as the size of the vibration devices 111, 121, and 131 decreases. In addition, the directivity of the sound may improve as the size of the vibration devices 111, 121, and 131 decreases.

According to an embodiment, since a resonance frequency of the vibration device occurs in a length direction of the vibration device, the vibration device having the rectangular plate shape may not be suitable for outputting an ultrasonic because the vibration device is separated into two frequencies due to a length difference between a long side and a short side.

According to an embodiment, the vibration device having the circular plate shape may have a highest sound pressure level characteristic. For example, when the vibration device having a square plate shape and the vibration device having the circular plate shape have a same area, in an audible frequency (200 Hz to 20 kHz), the vibration device having the circular plate shape may have a higher sound pressure level characteristic than the vibration device having the square plate shape. For example, since the vibration device having the circular plate shape may have a uniform displacement amount over an entire area, the vibration device having the circular plate shape may have a higher average displacement amount than that of the vibration device that have the square plate shape having a non-uniform displacement amount at corner portions.

According to an embodiment, the vibration device having a triangular plate shape may have a sound pressure level characteristic lower than that of the vibration device having the circular plate shape and may have a sound pressure level characteristic higher than that of the vibration device having the square plate shape. A plurality of vibration devices having the triangular plate shape may implement a vibration device having a polygonal shape having 2M (where M is a natural number greater than or equal to 2) sides.

The vibration device having the rectangular plate shape may be used for outputting any one of a sound, a directional sound, a vibration haptic, a texture haptic, and an ultrasonic haptic, but may be more preferably used to improve a sound pressure level of a sound based on a resonance frequency. The vibration device having the circular plate shape may be used for outputting any one of a sound, a directional sound, a vibration haptic, a texture haptic, and an ultrasonic haptic, but may be more preferably used to improve a sound pressure level of a sound. The plurality of vibration devices having the triangular plate shape may be used for outputting any one of a sound, a directional sound, a vibration haptic, a texture haptic, and an ultrasonic haptic, but may be more preferably used to generate (or output) the directional sound, the vibration haptic, the texture haptic, and the ultrasonic haptic.

Referring to FIGS. 2 and 3, each of the one or more first vibration devices 111, the one or more second vibration devices 121, and the one (or the plurality of) third vibration device 131 may include a vibration layer 111a, 121a, and 131a, a first electrode layer 111b, 121b, and 131b, and a second electrode layer 111c, 121c, and 131c.

The vibration layers 111a, 121a, and 131a according to an embodiment of the present disclosure may include a piezoelectric material or an electroactive material including a piezoelectric effect. For example, the vibration layers 111a, 121a, and 131a may be configured as a ceramic-based piezoelectric ceramic, or configured as a piezoelectric ceramic having a perovskite-based crystalline structure. The piezoelectric ceramic may be configured as a single crystalline ceramic having a crystalline structure, or configured as a ceramic material or polycrystalline ceramic having a polycrystalline structure. For example, the vibration layers 111a, 121a, and 131a may be a piezoelectric layer, a piezoelectric material layer, an electroactive layer, a piezoelectric composite, or a piezoelectric ceramic composite, or the like, but are not limited thereto.

The vibration layers 111a, 121a, and 131a according to another embodiment of the present disclosure may include a piezoelectric composite having flexible characteristic.

According to an embodiment, the piezoelectric composite of the vibration layers 111a, 121a, and 131a may include a plurality of piezoelectric material portions (or inorganic material portions) and a plurality of organic material portions (or flexible portions) configured to fill gaps between the plurality of piezoelectric material portions. For example, the plurality of piezoelectric material portions and the plurality of organic material portions may each include a line shape or a stripe shape which has a same size or a different size, but are not limited thereto.

According to another embodiment, the piezoelectric composite of the vibration layers 111a, 121a, and 131a may include a plurality of piezoelectric material portions (or inorganic material portions) and an organic material portion (or a flexible portion) disposed between the plurality of piezoelectric material portions. For example, each of the plurality of piezoelectric material portions may have a hexahedral shape and may be disposed in a lattice shape, but is not limited thereto. For example, each of the plurality of piezoelectric material portions may have a circular plate shape, an oval plate shape, or a polygonal plate shape. For example, the organic material portions may be configured to fill the gaps between two adjacent piezoelectric material portions among the plurality of piezoelectric material portions or to surround each of the plurality of piezoelectric material portions, and thus, the organic material portions may be connected or attached on the piezoelectric material portions adjacent thereto.

The vibration layers 111a, 121a, and 131a according to another embodiment of the present disclosure may have a single thin film-type in which the plurality of piezoelectric material portions and one or more organic material portions are disposed (or connected) in a same plane. Accordingly, the vibration devices 111, 121, and 131 including the vibration layers 111a, 121a, and 131a according to another embodiment of the present disclosure may vibrate due to the piezoelectric material portions having a vibration characteristic and may be bent in a curved shape due to the organic material portions having flexibility.

The first electrode layers 111b, 121b, and 131b may be disposed (or deposited) at a first surface (or a front surface) of the vibration layers 111a, 121a, and 131a. The second electrode layers 111c, 121c, and 131c may be disposed at a second surface (or a rear surface) of the vibration layers 111a, 121a, and 131a, which is different from or opposite to the first surface.

The vibration layers 111a, 121a, and 131a may be polarized (or poled) by a certain voltage applied to the first electrode layers 111b, 121b, and 131b and the second electrode layers 111c, 121c, and 131c in a certain temperature atmosphere, or a temperature atmosphere that may be changed from a high temperature to a room temperature, but are not limited thereto. The vibration layers 111a, 121a, and 131a may vibrate by alternately repeating contraction and/or expansion based on a reverse piezoelectric effect according to a driving signal applied to the first electrode layers 111b, 121b, and 131b and the second electrode layers 111c, 121c, and 131c from an outside.

The first cover member 140 may be configured to commonly cover a first surface (or a front surface) of each of the first, second, third vibration parts 110, 120, 130 to n-th vibration part. The first cover member 140 may be configured to commonly cover the first surface of each of the first to third vibration parts 110, 120, and 130 and protect the first surface of each of the first to third vibration parts 110, 120, and 130. The first cover member 140 may commonly support the first surfaces of each of the first to third vibration parts 110, 120, and 130. According to an embodiment, the first cover member 140 may include an adhesive layer. The first cover member 140 may be attached on the first surface of each of the first, second, third vibration parts 110, 120, 130 to n-th vibration part through the adhesive layer.

The second cover member 150 may be configured to commonly cover a second surface (or a rear surface) of each of the first, second, third vibration parts 110, 120, 130 to n-th vibration part, which are opposite to the first surface. The second cover member 150 may be configured to commonly cover the second surface of each of the first to third vibration parts 110, 120, and 130 and protect the second surface of each of the first to third vibration parts 110, 120, and 130. The second cover member 150 may commonly support the second surface of each of the first to third vibration parts 110, 120, and 130. According to an embodiment, the second cover member 150 may include an adhesive layer. The second cover member 150 may be attached on the second surface of each of the first, second, third vibration parts 110, 120, 130 to n-th vibration part through the adhesive layer.

Each of the first and second cover members 140 and 150 may include a first area A1, a second area A2 parallel to the first area A1, and a third area A3 between the first area A1 and the second area A2.

The first, second, third vibration parts 110, 120, 130 to n-th vibration part may be disposed (or interposed) between the first cover member 140 and the second cover member 150. According to an embodiment, the first vibration part 110 may be disposed (or interposed) between the first cover member 140 and the second cover member 150 corresponding to the first area A1. The second vibration part 120 may be disposed (or interposed) between the first cover member 140 and the second cover member 150 corresponding to the second area A2. The third vibration part 130 may be disposed (or interposed) between the first cover member 140 and the second cover member 150 corresponding to the third area A3.

The first and second cover members 140 and 150 may be made of a same material or a different material. For example, each of the first and second cover members 140 and 150 may be made of a plastic film, but is not limited thereto.

The vibration apparatus 100 according to the first embodiment of the present disclosure may further include a plurality of first signal supply lines 161, a plurality of second signal supply lines 162, and a pad part 163.

The plurality of first signal supply lines 161 may be disposed between the first surface of each of the first, second, third vibration parts 110, 120, 130 to n-th vibration part and the first cover member 140. The plurality of first signal supply lines 161 may be configured to be electrically connected to the first electrode layer 111b, 121b, and 131b of each of the first, second, third vibration parts 110, 120, 130 to n-th vibration part. The plurality of first signal supply lines 161 may be in direct contact with the first electrode layer 111b, 121b, and 131b of each of the first, second, third vibration parts 110, 120, 130 to n-th vibration part. The plurality of first signal supply lines 161 may individually contact the first electrode layer 111b, 121b, and 131b of each of the one or more first vibration devices 111, the one or more second vibration devices 121, and the one (or the plurality of) third vibration device 131. For example, the plurality of first signal supply lines 161 may be formed (or configured) at an inner surface 140i of the first cover member 140 facing the first surface of each of the first, second, third vibration parts 110, 120, 130 to n-th vibration part.

Each of the plurality of first signal supply lines 161 may include a first electrode contact portion 161a and a first link portion 161b.

The first electrode contact portion 161a may be configured to be electrically connected to the first electrode layer 111b, 121b, and 131b of each of the one or more first vibration devices 111, the one or more second vibration devices 121, and the plurality of third vibration devices 131. For example, the first electrode contact portion 161a may include one or more contact lines. For example, the first electrode contact portion 161a may have a line shape, but is not limited thereto, and may have a “U” shape in a plan view.

The first link portion 161b may be formed (or configured) to be electrically connected between one side of the first electrode contact portion 161a and the pad part 163. For example, the first link portion 161b may include an extension line extending from one side of the first electrode contact portion 161a toward the pad part 163.

The plurality of second signal supply lines 162 according to an embodiment may be disposed between the second surface of each of the first, second, third vibration parts 110, 120, 130 to n-th vibration part and the second cover member 150. The plurality of second signal supply lines 162 may be configured to be electrically connected to the second electrode layer 111c, 121c, and 131c of each of the first, second, third vibration parts 110, 120, 130 to n-th vibration part. The plurality of second signal supply lines 162 may be in direct contact with the second electrode layer 111c, 121c, and 131c of each of the first, second, third vibration parts 110, 120, 130 to n-th vibration part. The plurality of second signal supply lines 162 may individually contact the second electrode layer 111c, 121c, and 131c of each of the one or more first vibration devices 111, the one or more second vibration devices 121, and the plurality of third vibration devices 131. For example, the plurality of second signal supply lines 162 may be formed (or configured) on an inner surface 150i of the second cover member 150 facing the second surface of each of the first, second, third vibration parts 110, 120, 130 to n-th vibration part.

Each of the plurality of second signal supply lines 162 may include a second electrode contact portion 162a and a second link portion 162b.

The second electrode contact portion 162a may be configured to be electrically connected to the second electrode layer 111c, 121c, and 131c of each of the one or more first vibration devices 111, the one or more second vibration devices 121, and the plurality of third vibration devices 131. For example, the second electrode contact portion 162a may include one or more contact lines. For example, the second electrode contact portion 162a may have a line shape, but is not limited thereto, and may have a “U” shape in a plan view.

The second link portion 162b may be formed (or configured) to be electrically connected between one side of the second electrode contact portion 162a and the pad part 163. For example, the second link portion 162b may include an extension line extending from one side of the second electrode contact portion 162a toward the pad part 163.

The pad part 163 may be disposed (or configured) at the first cover member 140 and the second cover member 150 and may be configured to be electrically connected to the plurality of first signal supply lines 161 and the plurality of second signal supply lines 162.

The pad part 163 may include a plurality of first pads 163a and a plurality of second pads 163b.

The plurality of first pads 163a may be disposed (or configured) at the inner surface 140i of the first cover member 140 and may be configured to be electrically connected to the plurality of first signal supply lines 161. The plurality of first pads 163a may be electrically connected to the first link portions 161b of each of the plurality of first signal supply lines 161.

The plurality of second pads 163b may be disposed (or configured) at the inner surface 150i of the second cover member 150 and may be configured to be electrically connected to the plurality of second signal supply lines 162. The plurality of second pads 163b may be electrically connected to the second link portions 162b of each of the plurality of second signal supply lines 162. For example, the plurality of second pads 163b may be disposed (or configured) so as not to overlap with the plurality of first pads 163a.

In FIGS. 1 to 3, although the second electrode layers 111c, 121c, and 131c of each of the one or more first vibration devices 111, the one or more second vibration devices 121, and the plurality of third vibration devices 131 are shown and described as being individually contacted (or connected) with the plurality of second signal supply lines 162, but is not limited thereto. For example, the plurality of second signal supply lines 162 may be replaced with one common signal line (or a single common signal line). In this case, the second electrode layers 111c, 121c, and 131c of each of the one or more first vibration devices 111, the one or more second vibration devices 121, and the plurality of third vibration devices 131 may be commonly contacted (or connected) with one common signal line.

The vibration apparatus 100 according to the first embodiment of the present disclosure may further include an adhesive member 165.

The adhesive member 165 may be disposed between the first cover member 140 and the second cover member 150 and may be configured to surround side surfaces of each of the first, second, third vibration parts 110, 120, 130 to n-th vibration part. The adhesive member 165 may include an electrically insulating material which has adhesiveness and is capable of compression and decompression. For example, the adhesive member 165 may include an epoxy resin, an acrylic resin, a silicone resin, or a urethane resin, but is not limited thereto.

The first cover member 140 may be coupled to the first surface of each of the first, second, third vibration parts 110, 120, 130 to n-th vibration part through the adhesive member 165. Accordingly, each of the plurality of first signal supply lines 161 may be maintained with being electrically connected to the first electrode layer 111b, 121b, and 131b of each of the one or more first vibration devices 111, the one or more second vibration devices 121, and the plurality of third vibration devices 131.

The second cover member 150 may be coupled to the second surfaces of each of the first, second, third vibration parts 110, 120, 130 to n-th vibration part through the adhesive member 165. Accordingly, each of the plurality of second signal supply lines 162 may be maintained with being electrically connected to the second electrode layer 111c, 121c, and 131c of each of the one or more first vibration devices 111, the one or more second vibration devices 121, and the plurality of third vibration devices 131.

According to an embodiment of the present disclosure, the first, second, third vibration parts 110, 120, 130 to n-th vibration part may be disposed (or configured) between the first cover member 140 and the second cover member 150 by the adhesive member 165, and thus, the first, second, third vibration parts 110, 120, 130 to n-th vibration part may be implemented in a film form integrated with the first and second cover members 140, 150. For example, the first, second, third vibration parts 110, 120, 130 to n-th vibration part may be configured or structured as one vibration apparatus (or a single vibration apparatus), and thus, an effect of uni-materialization can be obtained. Accordingly, the vibration apparatus 100 according to the first embodiment of the present disclosure may be flexible and thinned.

Referring to FIGS. 1 to 3, the vibration apparatus 100 according to the first embodiment of the present disclosure may further include a signal cable 170.

The signal cable 170 may be disposed to be electrically connected to the pad part 163. The signal cable 170 may include a plurality of first signal lines 171 individually connected to a plurality of first pads 163a, and a plurality of second signal lines 172 individually connected to a plurality of second pads 163b.

One side portion (or end portion) 170e of the signal cable 170 may be accommodated (or inserted) between the first cover member 140 and the second cover member 150. For example, one side portion (or end portion) 170e of the signal cable 170 may be a portion overlapping (or connected to) the pad part 163. For example, one side portion (or end portion) 170e of the signal cable 170 may be accommodated (or inserted) between one side edge of the first cover member 140 and one side edge of the second cover member 150. For example, one side portion (or end portion) 170e of the signal cable 170 may be inserted into an adhesive member 165 disposed between one side edge of the first cover member 140 and one side edge of the second cover member 150. Accordingly, the signal cable 170 may be integrated with the first, second, third vibration parts 110, 120, 130 to n-th vibration part. Therefore, the vibration apparatus 100 and the signal cable 170 may be implemented in a film form integrated with each other, and thus, an effect of uni-materialization can be obtained.

The vibration apparatus 100 according to the first embodiment of the present disclosure may further include a vibration driving circuit 180.

The vibration driving circuit 180 may be electrically connected to the pad part 163 through the signal cable 170. The vibration driving circuit 180 may be configured to vibrate the first, second, third vibration parts 110, 120, 130 to n-th vibration part. The vibration driving circuit 180 may be configured to supply a vibration driving signal to each of the first, second, third vibration parts 110, 120, 130 to n-th vibration part. Each of the first, second, third vibration parts 110, 120, 130 to n-th vibration part may be driven (or vibrated) at a same driving frequency or at different driving frequencies based on the vibration driving signal. For example, the one or more first vibration devices 111, the one or more second vibration devices 121, and the plurality of third vibration devices 131 may each be driven (or vibrated) at a same driving frequency or at different driving frequencies based on the vibration driving signal.

The vibration driving signal may include one or more of a sound signal corresponding to a sound, a directional sound signal corresponding to a directional sound, a vibration haptic signal corresponding to a vibration haptic, a texture haptic signal corresponding to a texture haptic, and an ultrasonic haptic signal corresponding to an ultrasonic haptic. For example, the vibration driving signal supplied to each of the first, second, third vibration parts 110, 120, 130 to n-th vibration part may include any one of the sound signal corresponding to the sound, the directional sound signal corresponding to the directional sound, the vibration haptic signal corresponding to the vibration haptic, the texture haptic signal corresponding to the texture haptic, and the ultrasonic haptic signal corresponding to the ultrasonic haptic.

According to an embodiment, the sound signal (or a sound driving signal) may be for outputting a sound corresponding to a sound source signal applied from a host control system and may have a frequency band of 50 Hz to 20 kHz. For example, the sound signal may include a low-pitched sound band signal and a middle-high-pitched sound band signal. For example, the low-pitched sound band may be 200 Hz or less, a middle-pitched band may be from 200 Hz to 3 kHz, and a high-pitched band may be 3 kHz or more, but is not limited thereto. The directional sound signal (or a directional sound driving signal) may be for outputting a sound corresponding to a sound source signal only in a specific direction (or area) and may include a sound signal with a frequency band of 50 Hz to less than 20 kHz and an ultrasonic carrier signal of 20 kHz (or 40 kHz) or more.

According to an embodiment, the vibration haptic signal (or a vibration haptic driving signal) may be for outputting a vibration haptic corresponding to a vibration haptic (or a vibration haptic information) applied from the host control system and may have a frequency band of 50 Hz to less than 150 Hz.

According to an embodiment, the texture haptic signal (or a texture haptic driving signal) may be for outputting a texture haptic corresponding to a texture haptic (or a texture haptic information) applied from the host control system and may have a frequency band of 150 Hz to 300 Hz. For example, the texture haptic (or the texture haptic information) may include a push haptic corresponding to a push touch (or press touch), an option box haptic corresponding to a long touch, and a slide haptic corresponding to a slide touch (or touch-and-drag). The vibration haptic may comprise any one of a push haptic corresponding to a push touch, an option box haptic corresponding to a long touch, and a slide haptic corresponding to a slide touch. The vibration haptic signal may comprise any one of a push haptic signal corresponding to the push touch, an option box haptic signal corresponding to the long touch, and a slide haptic signal corresponding to the slide touch.

According to an embodiment, the ultrasonic haptic signal (or an ultrasonic haptic driving signal) may be for outputting an ultrasonic haptic corresponding to an ultrasonic haptic (or an ultrasonic haptic information) applied from a host control system and may have a frequency band of 40 Hz or more. According to another embodiment, the ultrasonic haptic signal may include a vibration haptic signal with a frequency band of 50 Hz to less than 150 Hz corresponding to a vibration haptic (or a vibration haptic information) and an ultrasonic carrier signal of 40 Hz or more.

The vibration driving circuit 180 may be configured to supply any one of the sound signal corresponding to a sound, the directional sound signal corresponding to a directional sound, the vibration haptic signal corresponding to a vibration haptic, the texture haptic signal corresponding to a texture haptic, and the ultrasonic haptic signal corresponding to an ultrasonic haptic to each of the first, second, third vibration parts 110, 120, 130 to n-th vibration part.

According to an embodiment, each of the first, second, third vibration parts 110, 120, 130 to n-th vibration part may output any one of the sound, the directional sound, the vibration haptic, the texture haptic, and the ultrasonic haptic. For example, the sound, the directional sound, the vibration haptic, the texture haptic, and the ultrasonic haptic may each be output by one or more of the first, second, third vibration parts 110, 120, 130 to n-th vibration part. For example, one of the sound, the directional sound, the vibration haptic, the texture haptic, and the ultrasonic haptic may be output by one or more of the first, second, third vibration parts 110, 120, 130 to n-th vibration part. For example, two of the sound, the directional sound, the vibration haptic, the texture haptic, and the ultrasonic haptic may be simultaneously output by two or more of the first, second, third vibration parts 110, 120, 130 to n-th vibration part. For example, the first, second, third vibration parts 110, 120, 130 to n-th vibration part may simultaneously output two texture haptics of different textures.

The vibration driving circuit 180 may include a driving signal generating part 181 and an amplifier part 183.

The driving signal generating part 181 may be a sound source processing circuit or a vibration control circuit.

The driving signal generating part 181 may be configured to supply any one of the sound signal corresponding to a sound, the directional sound signal corresponding to a directional sound, the vibration haptic signal corresponding to a vibration haptic, the texture haptic signal corresponding to a texture haptic, and the ultrasonic haptic signal corresponding to an ultrasonic haptic to each of the first, second, third vibration parts 110, 120, 130 to n-th vibration part.

According to an embodiment, the driving signal generating part 181 may be configured to generate the sound signal having a frequency band of 50 Hz to 20 kHz based on a sound source signal applied from the host control system.

The driving signal generating part 181 may be configured to generate a directional sound signal including the sound signal with the frequency band of 50 Hz to less than 20 kHz and the ultrasonic carrier signal of 20 kHz (or 40 kHz) or more based on the sound source signal applied from the host control system. For example, the driving signal generating part 181 may generate the directional audio signal through amplitude modulation of the sound signal and the ultrasonic carrier signal. For example, the driving signal generating part 181 may generate the directional sound signal through amplitude modulation of the ultrasonic carrier signal based on the sound signal.

The driving signal generating part 181 may be configured to generate the vibration haptic signal having the frequency band of 50 Hz to less than 150 Hz based on the vibration haptic corresponding to a touch applied from the host control system.

The driving signal generating part 181 may be configured to generate the texture haptic signal having the frequency band of 150 Hz to 300 Hz based on the texture haptic corresponding to the texture touch applied from the host control system. For example, the texture haptic may include the push haptic corresponding to the push touch, the option box haptic corresponding to the long touch, and the slide haptic corresponding to the slide touch. For example, the driving signal generating part 181 may be configured to generate the texture haptic signal corresponding to any one of a push haptic signal corresponding to the push touch, an option box haptic signal corresponding to the long touch, and a slide haptic signal corresponding to the slide touch based on the texture haptic.

The driving signal generating part 181 may be configured to generate the ultrasonic haptic signal having the frequency band of 40 kHz or more based on the texture haptic corresponding to a touch applied from the host control system.

According to an embodiment, the driving signal generating part 181 may include an internal memory that stores frequency information and waveform information for the texture haptic signal corresponding to the texture haptic. For example, the internal memory may be configured to store push haptic frequency information and push haptic waveform information for the push haptic signal, option box haptic frequency information and option box haptic waveform information for the option box haptic signal, and slide haptic frequency information and slide haptic waveform information for the slide haptic signal.

The amplifier part 183 may be configured to amplify and output the vibration driving signals of the first, second, third vibration parts 110, 120, 130 to n-th vibration part supplied from the driving signal generating part 181. For example, the amplifier part 183 may be configured to amplify and output the vibration driving signals of the first, second, third vibration parts 110, 120, 130 to n-th vibration part according to a predetermined gain value. Accordingly, the vibration driving signals output from the amplifier part 183 may be supplied to corresponding vibration parts 110, 120, and 130 through the signal cable 170, the pad part 163, and the signal supply lines 161 and 162. Therefore, each of the one or more first vibration devices 111, the one or more second vibration devices 121, and the plurality of third vibration devices 131 may be driven (or vibrated or displaced) at a same driving frequency or at different driving frequencies by the vibration driving signals supplied from the amplifier part 183. For example, each of the one or more (or the plurality of) first vibration devices 111, the one or more second (or the plurality of) vibration devices 121, and the one third vibration device 131 may be driven (or vibrated or displaced) by the vibration driving signals supplied from the amplifier part 183 to output one or more of the sound, the directional sound, the vibration haptic, the texture haptic, and the ultrasonic haptic.

As described above, the vibration apparatus 100 according to the first embodiment of the present disclosure may be disposed between the first and second cover members 140 and 150 and may include a plurality of vibration parts 110, 120, and 130 having a piezoelectric material, and thus, may be driven at various frequencies and may be capable of flexibility and thinning. Furthermore, the vibration apparatus 100 according to the first embodiment of the present disclosure may output one of the sound, the directional sound, the vibration haptic, the texture haptic, and the ultrasonic haptic based on the driving (or vibration or displacement) of the first, second, third vibration parts 110, 120, 130 to n-th vibration part, or may simultaneously output two or three of them, and may output a haptic feedback of various textures.

In addition, in the vibration apparatus 100 according to the first embodiment of the present disclosure, since the vibration devices 111 and 121 having a relatively large size and the circular plate shape are disposed in each of the first and second areas A1 and A2, strong vibration (or displacement) may be generated in each of the first and second areas A1 and A2, and thus, a sound having directionality (or directivity) may be output. Furthermore, when haptic is driven based on a driving frequency of 150 Hz, strong vibration (or displacement) may be generated in the central area, and when vibration haptic and/or texture haptic is driven based on a driving frequency of 250 Hz, vibration may be concentrated in the central area, and thus, the user's recognition (or perception) characteristic of the vibration haptic and/or the texture haptic may be further improved. Moreover, when sound is output, relatively strong vibration may be generated in each of the first and second vibration parts 110 and 120 having a relatively large size, and thus, the vibration apparatus 100 may vibrate uniformly over an entire area (or an entire surface).

FIG. 4 is a plan view illustrating a vibration apparatus according to a second embodiment of the present disclosure. FIG. 4 illustrates an embodiment where the third vibration part in the vibration apparatus described above with reference to FIGS. 1 to 3 have been modified. In the following description, therefore, only a modified element will be described in detail, the other elements are referred to by the same reference numerals as FIGS. 1 to 3, and their repetitive descriptions are omitted or will be briefly given. Therefore, descriptions above with reference to FIGS. 1 to 3 may be included in descriptions of FIG. 4.

Referring to FIG. 4, in the vibration apparatus 200 according to the second embodiment of the present disclosure, the first vibration part 110 may be disposed at the first area A1, the second vibration part 120 may be disposed at the second area A2, and the third vibration part 130 may be disposed at the third area A3.

The first vibration part 110 may include one first vibration device (or a single first vibration device) 111 having a circular plate shape. The first vibration part 110 may substantially the same as the first vibration part 110 described above with reference to FIGS. 1 to 3, and thus, the repetitive description thereof may be omitted.

The second vibration part 120 may include one second vibration device (or a single second vibration device) 121 having a circular plate shape. The second vibration part 120 may substantially the same as the second vibration part 120 described above with reference to FIGS. 1 to 3, and thus, the repetitive description thereof may be omitted.

The third vibration part 130 may include a plurality of third vibration devices 131 having a triangular plate shape. The third vibration part 130 may include a plurality of third vibration devices 131 having the equilateral triangular plate shape. Each of the plurality of third vibration devices 131 may include the triangular plate shape having a same size (or a same area). For example, the plurality of third vibration devices 131 may be disposed to form a polygonal shape in a plan view, but is not limited thereto. For example, the plurality of third vibration devices 131 may be disposed to form a hexagonal shape in a plan view. For example, vertices of the plurality of third vibration devices 131 having the equilateral triangular plate shape may be disposed to face a center portion CP of the third area A3 (or the vibration apparatus 200). For example, the third vibration part 130 may include six third vibration devices 131 having the equilateral triangular plate shape. The six third vibration devices 131 may be disposed to form a hexagonal shape in a plan view.

According to an embodiment, distances between the vertices of the plurality of third vibration devices 131 having the equilateral triangular plate shape and the center portion CP of the third area A3 (or the vibration apparatus 200) may all be a same. Accordingly, the plurality of third vibration devices 131 may be disposed to form a regularly hexagonal shape, and thus, may be implemented as a vibration source (or a vibration body) close to a circular shape.

According to another embodiment, as illustrated in FIG. 5, some of distances between the vertices of the plurality of third vibration devices 131 having the equilateral triangular plate shape and the center portion CP of the third area A3 may be different. For example, when the plurality of third vibration devices 131 are disposed in two rows and three columns (2×3) in the third area A3, among distances between the vertices of each of the plurality of third vibration devices 131 and the center portion CP of the third area A3, distance of the third vibration device 131 disposed in the second column may be closer than that of distance of the third vibration device 131 disposed in the first and third columns. Accordingly, the plurality of third vibration devices 131 may be disposed to form a hexagonal shape rather than the regularly hexagonal shape, and may be implemented as a vibration source (or a vibration body) close to a circular shape or an oval (or elliptical) shape.

A total size (or area) of the plurality of third vibration devices 131 may be smaller than each of the one first vibration device 111 and the one second vibration device 121.

The one first vibration device 111 and the one second vibration device 121 may have a symmetrical (or a horizontal or left-right symmetric) structure with respect to the center portion CP of the third area A3, and the plurality of third vibration devices 131 may have both vertical and horizontal (or upper-lower and left-right) symmetrical structures with respect to the center portion CP of the third area A3.

Except for that six third vibration devices 131 having the equilateral triangular plate shape are disposed to form a regularly hexagonal shape in a plan view, the third vibration part 130 may substantially the same as the first vibration part 130 described above with reference to FIGS. 1 to 3, and thus, the repetitive description thereof may be omitted.

Since the plurality of third vibration devices 131 may be disposed to form the regularly hexagonal shape, the third vibration part 130 according to an embodiment may be implemented as a vibration source (or a vibration body) close to a circular shape, thereby improving a vibration characteristic or a sound output characteristic, and may have a sound characteristic and/or a sound pressure level characteristic similar to those of each of the first and second vibration parts 110 and 120 having a circular plate-shaped vibration devices 111 and 121.

Since the vibration apparatus 200 according to the second embodiment of the present disclosure may have the same effects as the vibration apparatus 100 according to the first embodiment of the present disclosure described above with reference to FIGS. 1 to 3, and thus, the repetitive description thereof may be omitted. Furthermore, in the vibration apparatus 200 according to the second embodiment of the present disclosure, since the vibration devices 111 and 121 having a circular plate shape may be disposed at the first and second areas A1 and A2, respectively, and the plurality of third vibration devices 131 forming the regularly hexagonal shape close to a circular shape may be disposed at the third area A3, strong vibration (or displacement) may be generated in a central area, and thus, a sound characteristic and/or a sound pressure level characteristic of a low-pitched sound band may be improved. Furthermore, when haptic is driven, the user's recognition (or perception) characteristic of the vibration haptic and/or the texture haptic may be further improved.

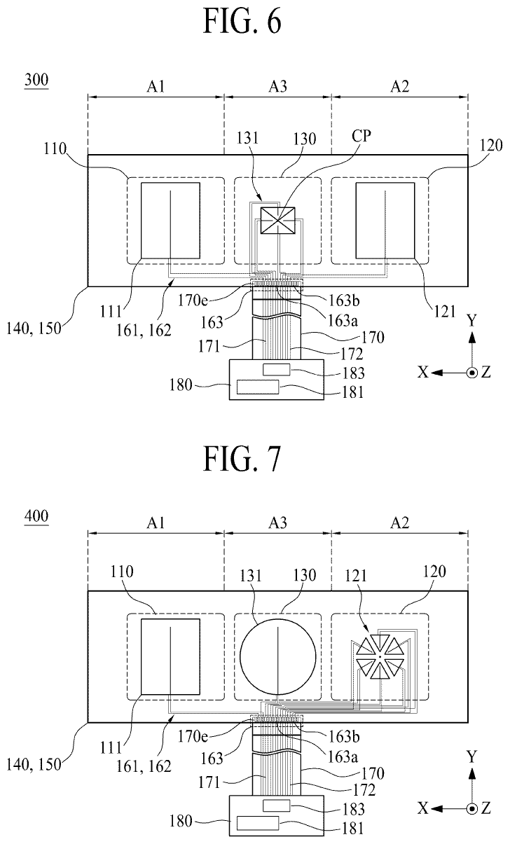

FIG. 6 is a plan view illustrating a vibration apparatus according to a third embodiment of the present disclosure. FIG. 6 illustrates an embodiment where the first to third vibration parts in the vibration apparatus described above with reference to FIGS. 1 to 3 have been modified. In the following description, therefore, only a modified element will be described in detail, the other elements are referred to by the same reference numerals as FIGS. 1 to 3, and their repetitive descriptions are omitted or will be briefly given. Therefore, descriptions above with reference to FIGS. 1 to 3 may be included in descriptions of FIG. 6.

Referring to FIG. 6, in the vibration apparatus 300 according to the third embodiment of the present disclosure, the first vibration part 110 may be disposed at the first area A1, the second vibration part 120 may be disposed at the second area A2, and the third vibration part 130 may be disposed at the third area A3.

The first vibration part 110 may include one first vibration device (or a single first vibration device) 111 having a quadrangular plate shape. The one first vibration device 111 may include a rectangular plate shape or rectangular shape having a long side parallel to a short side of the vibration apparatus 300 and a short side parallel to a long side of the vibration apparatus 300, but is not limited thereto. For example, the one first vibration device 111 may have a square plate shape or square shape. Except for that the one first vibration device 111 has the quadrangular plate shape (or a rectangular plate shape or a square plate shape), the first vibration part 110 may substantially the same as the first vibration part 110 described above with reference to FIGS. 1 to 3, and thus, the repetitive description thereof may be omitted.

The second vibration part 120 may include one second vibration device (or a single second vibration device) 121 having a quadrangular plate shape. The one second vibration device 121 may have a same shape as the one first vibration device 111, but is not limited thereto. For example, the one second vibration device 121 may have a same shape as the one first vibration device 111 among a rectangular plate shape and a square plate shape, or may have a different shape. Furthermore, the one second vibration device 121 may have a same size (or a same area) as the one first vibration device 111, or may have a different size (or a different area).

Each of the first vibration part 110 and the second vibration part 120 may output any one of a sound, a directional sound, a vibration haptic, a texture haptic, and an ultrasonic haptic. Furthermore, each of the first vibration part 110 and the second vibration part 120 includes the one vibration device 111 and 121 having the quadrangular plate shape, and thus, may have a relatively large size for improving a sound pressure level of a sound based on a resonance frequency.

The third vibration part 130 may include a plurality of third vibration devices 131 having a triangular plate shape. The third vibration part 130 may include a plurality of third vibration devices 131 having an isosceles triangular plate shape. Some of the plurality of third vibration devices 131 may have an isosceles triangular plate shape having a different size (or a different area).

According to an embodiment, the plurality of third vibration devices 131 having the isosceles triangular plate shape may be disposed to form a quadrangular shape (or a rectangular shape) in a plan view. For example, the isosceles of adjacent third vibration devices among the plurality of third vibration devices 131 having an isosceles triangular plate shape may contact each other without an interval (or a gap). For example, vertices of each of the plurality of third vibration devices 131 having the isosceles triangular plate shape may be located at a center of the third area A3 (or a center of the vibration apparatus 200). Accordingly, the third vibration part 130 may have a rectangular shape in a plan view, but is not limited thereto.

According to another embodiment, the isosceles of adjacent third vibration devices among the plurality of third vibration devices 131 having the isosceles triangular plate shape may be spaced apart at a predetermined interval, and thus, the plurality of third vibration devices 131 (or the third vibration part 130) may have a quadrangular shape (or a square shape) in a plan view.

The third vibration part 130 may include four third vibration devices 131 having the isosceles triangular plate shape. Among the four third vibration devices 131, sizes of the two third vibration devices 131 whose bases are parallel to a short side of the vibration apparatus 300 may be smaller than sizes of the two third vibration devices 131 whose bases are parallel to a long side of the vibration apparatus 300. As an embodiment, the four third vibration devices 131 having the isosceles triangular plate shape may be disposed to contact each other without an interval (or a gap), and thus, may be disposed to form a rectangular shape in a plan view, but are not limited thereto. As another embodiment, the four third vibration devices 131 having the isosceles triangular plate shape may be spaced apart at a predetermined interval, and thus, the four third vibration devices 131 (or the third vibration part 130) may have a quadrangular shape (or a square shape) in a plan view.

A total size (or a total area) of the plurality of third vibration devices 131 may be smaller than each of the one first vibration device 111 and the one second vibration device 121.

The one first vibration device 111 and the one second vibration device 121 may have a symmetrical (or a horizontal or left-right symmetric) structure with respect to the center portion CP of the third area A3, and the plurality of third vibration devices 131 may have both vertical and horizontal (or upper-lower and left-right) symmetrical structures with respect to the center portion CP of the third area A3.

Except for that the four third vibration devices 131 having the isosceles triangular plate shape are disposed to form a rectangular shape (or a square shape) in a plan view, the third vibration part 130 may substantially the same as the third vibration part 130 described above with reference to FIGS. 1 to 3, and thus, the repetitive description thereof may be omitted.

In the third vibration part 130 according to an embodiment, a plurality of third vibration devices 131 having the isosceles triangular plate shape may be disposed at the third area A3 to form a quadrangular shape, strong vibration (or displacement) may be generated in a central area, and thus, a sound characteristic and/or a sound pressure level characteristic of a low-pitched sound band may be improved. Furthermore, when haptic is driven, the user's recognition (or perception) characteristic of the vibration haptic and/or the texture haptic may be further improved.

Since the vibration apparatus 300 according to the third embodiment of the present disclosure may have the same effects as the vibration apparatus 100 according to the first embodiment of the present disclosure described above with reference to FIGS. 1 to 3, and thus, the repetitive description thereof may be omitted. Furthermore, in the vibration apparatus 300 according to the third embodiment of the present disclosure, since the vibration devices 111 and 121 having a relatively large size and a quadrangular plate shape may be disposed at the first and second areas A1 and A2, respectively, strong vibration (or displacement) may be generated in each of the first and second areas A1 and A2, and thus, a sound having directionality (or directivity) may be output. In addition, since the plurality of third vibration devices 131 having the isosceles triangular plate shape are disposed at the third area A3 to form a quadrangular shape, when haptic is driven based on a driving frequency of 150 Hz, strong vibration (or displacement) may be generated in the central area, and when vibration haptic and/or texture haptic is driven based on a driving frequency of 250 Hz, vibration may be concentrated in the central area, and thus, the user's recognition (or perception) characteristic of the vibration haptic and/or the texture haptic may be further improved. Moreover, when sound is output, relatively strong vibration may be generated in each of the first and second vibration parts 110 and 120 having a relatively large size, and thus, the vibration apparatus 300 may vibrate uniformly over an entire area (or an entire surface).

FIG. 7 is a plan view illustrating a vibration apparatus according to a fourth embodiment of the present disclosure. FIG. 7 illustrates an embodiment where the first to third vibration parts in the vibration apparatus described above with reference to FIGS. 1 to 3 have been modified. In the following description, therefore, only a modified element will be described in detail, the other elements are referred to by the same reference numerals as FIGS. 1 to 3, and their repetitive descriptions are omitted or will be briefly given. Therefore, descriptions above with reference to FIGS. 1 to 3 may be included in descriptions of FIG. 7.

Referring to FIG. 7, in the vibration apparatus 400 according to the fourth embodiment of the present disclosure, the first vibration part 110 may be disposed at the first area A1, the second vibration part 120 may be disposed at the second area A2, and the third vibration part 130 may be disposed at the third area A3.

The first vibration part 110 may include one first vibration device (or a single first vibration device) 111 having a quadrangular plate shape or a rectangular shape or a square shape. For example, the one first vibration device 111 may substantially the same as the one first vibration device 111 described above with reference to FIG. 6, and thus, the repetitive description thereof may be omitted.

The second vibration part 120 may include a plurality of second vibration devices 121 having a triangular plate shape or an equilateral triangular plate shape. For example, except for that the plurality of second vibration devices 121 are disposed at the second area A2, the plurality of second vibration devices 121 may substantially the same as the plurality of third vibration devices 131 described above with reference to FIG. 4 or 5, and thus, the repetitive description thereof may be omitted. For example, the second vibration part 120 illustrated in FIG. 7 may be replaced with the plurality of third vibration devices 131 described above with reference to FIG. 1 or 4, or may be replaced with the plurality of third vibration devices 131 described above with reference to FIG. 5 or 6.

The third vibration part 130 may include one third vibration device (or a single third vibration device) 131 having a circular plate shape. For example, except for that the one third vibration device 131 is disposed at the third area A3, the one third vibration device 131 may substantially the same as the one first vibration device 111 described above with reference to FIGS. 1 to 3, and thus, the repetitive description thereof may be omitted.

A total size (or a total area) of the plurality of second vibration devices 121 may be smaller than each of the one first vibration device 111 and the one third vibration device 131. For example, a size (or area) of the one third vibration device 131 may be larger than a size (or area) of the one first vibration device 111, but is not limited thereto.

The vibration apparatus 400 according to the fourth embodiment of the present disclosure may have the same effects as the vibration apparatus 100 according to the first embodiment described above with reference to FIGS. 1 to 3, and thus, the repetitive description thereof may be omitted.

In the vibration apparatus 400 according to the fourth embodiment of the present disclosure, since a quadrangular plate-shaped vibration device 111 having a relatively large size may be disposed at the first area A1, strong vibration (or displacement) may be generated in the first area A1, and thus, a sound having directionality (or directivity) may be output. Furthermore, since a circular plate-shaped third vibration device 131 having a relatively large size may be disposed at the third area A3, strong vibration (or displacement) may be generated in the central area, and thus, a sound characteristic and/or a sound pressure level characteristic of a low-pitched sound band may be improved. Moreover, when haptic is driven, the user's recognition (or perception) characteristic of the vibration haptic and/or the texture haptic may be further improved. In addition, since the plurality of second vibration devices 121 forming the regularly hexagonal shape close to a circular shape may be disposed at the second area A2, strong vibration (or displacement) may be generated in the second area A2, and thus, a sound having directionality (or directivity) may be output. Furthermore, when haptic is driven, the user's recognition (or perception) characteristic of the vibration haptic and/or the texture haptic may be further improved.

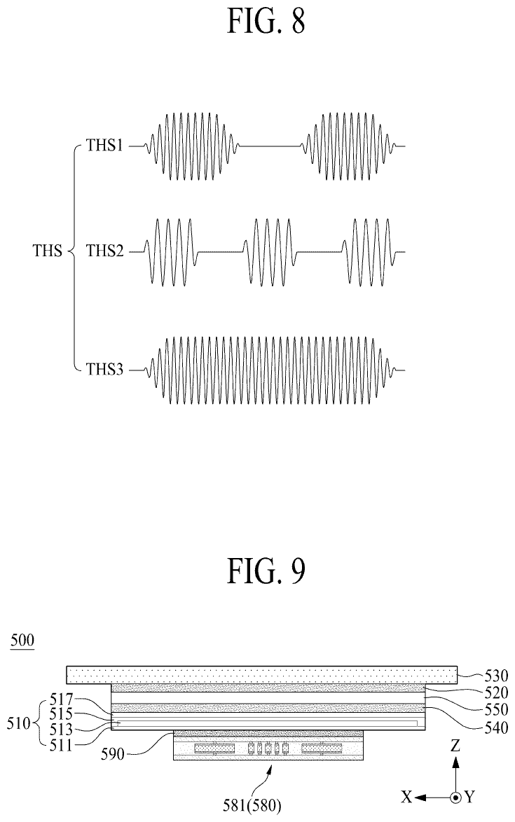

FIG. 8 is a waveform diagram illustrating a texture haptic signal according to an embodiment of the present disclosure.

Referring to FIG. 8, a texture haptic signal THS according to an embodiment of the present disclosure may be any one of a push haptic signal THS1, an option box haptic signal THS2, and a slide haptic signal THS3.

The push haptic signal THS1 according to an embodiment may be generated to implement a forward and backward (or front and rear) fading effect. For example, the push haptic signal THS1 may include a plurality of push haptic waveforms that are intermittently generated. Each of the plurality of push haptic waveforms may include a sine wave having a first section in which amplitude gradually increases, a second section in which amplitude is maintained constant, and a third section in which amplitude gradually decreases. Accordingly, the user may perceive the push haptic through the plurality of push haptic waveforms including the first to third sections.

The option box haptic signal THS2 according to an embodiment may be generated to implement an effect lasting for a certain time. For example, the option box haptic signal THS2 may include a plurality of option box haptic waveforms that are intermittently generated. Each of the plurality of option box haptic waveforms may include a sine wave having a same amplitude for a certain time. Accordingly, the user may perceive the option box haptic through the plurality of option box haptic waveforms.

The slide haptic signal THS3 according to an embodiment may be generated to implement an effect lasting for a certain time and a forward and backward (or front and rear) fading effect. For example, the slide haptic signal THS3 may include a slide haptic waveform generated for a certain time. The slide haptic waveform may include a sine wave having a first section in which amplitude gradually increases, a second section in which amplitude is maintained constant, and a third section in which amplitude gradually decreases. Accordingly, the user may perceive the slide haptic through the slide haptic waveform including the first to third sections.

FIG. 9 is a cross-sectional view illustrating a display apparatus according to a first embodiment of the present disclosure.

Referring to FIG. 9, a display apparatus 500 according to a first embodiment of the present disclosure may include a display panel 510 and one or more vibration generating apparatuses 580.

The display panel 510 may be configured to display an image (or still image). For example, the display panel 510 may be configured to display a plurality of vehicle control icons (or user interface icons) including one or more of an image, a character, a shape, a sign, a symbol, and a number. For example, the display panel 510 may include a smart surface display. For example, the display panel 510 may be a smart surface display panel.

The display panel 510 according to an embodiment may include a base substrate 511, a pixel array part 513 disposed (or configured) on the base substrate 511, and an optical film 517 attached to a front surface of the pixel array part 513.

The base substrate 511 may be made of a plastic material, but is not limited thereto.

The pixel array part 513 may include a plurality of pixel cells disposed (or configured) at predetermined positions on the base substrate 511. For example, each of the plurality of pixel cells may include one or more light emitting diodes.

The optical film 517 may be disposed (or configured) to cover an entire front surface of the pixel array part 513. The optical film 517 may be attached to the entire front surface of the pixel array part 513 by using a transparent adhesive layer 515. The optical film 517 may include a plurality of vehicle control icons corresponding to each of the plurality of pixel cells. For example, the plurality of vehicle control icons may include one or more of an image, a character, a shape, a sign, a symbol, and a number.

The display panel 510 may provide one or more of the plurality of vehicle control icons to the user based on light emission of one or more light emitting diodes.

The display apparatus 500 according to the first embodiment of the present disclosure may further include a cover window 530.

The cover window 530 may be configured to cover a front surface of the display panel 510. For example, the cover window 530 may be attached to the front surface of the display panel 510 by using a first transparent adhesive member 520. For example, the cover window 530 may protect the display panel 510 from external impact or block impacts applied to the display panel 510. For example, the cover window 530 may be made of a transparent plastic material or a glass material, but is not limited thereto.

The display apparatus 500 according to the first embodiment of the present disclosure may further include a touch panel 550. The touch panel 550 may be disposed (or interposed) between the cover window 530 and the display panel 510 and configured to sense a user touch on the cover window 530.

The touch panel 550 according to an embodiment may include a touch electrode layer including a plurality of touch driving lines and a plurality of touch sensing lines based on a mutual capacitance scheme. The touch panel 550 according to another embodiment may include a touch electrode layer including a plurality of touch electrodes based on a self-capacitance scheme.

The touch panel 550 may be attached to the front surface of the display panel 510 by using a second transparent adhesive member 540 and coupled to the cover window 530 by the first transparent adhesive member 520. For example, the cover window 530 may be attached to a front surface of the touch panel 550 by using the first transparent adhesive member 520.

The one or more vibration generating apparatuses 580 may be configured to vibrate the display panel 510. The one or more vibration generating apparatuses 580 may be attached to a rear surface of the display panel 510. The one or more vibration generating apparatuses 580 may be attached to the rear surface of the display panel 510 by using a coupling member 590.

The one or more vibration generating apparatuses 580 may vibrate the display panel 510 to output one of a sound, a directional sound, a vibration haptic, a texture haptic, and an ultrasonic haptic, or to simultaneously output two or three of them. For example, the display panel 510 may be used as a vibration member (or a vibration plate or a sound plate) that vibrates based on the driving (or vibration or displacement) of the one or more vibration generating apparatuses 580 to generate (or output) a sound and/or a vibration.

The one or more vibration generating apparatuses 580 may include a vibration apparatus 581.

The vibration apparatus 581 according to an embodiment may substantially a same as the vibration apparatus 100 described above with reference to FIGS. 1 to 3, and thus, the repetitive description thereof may be omitted. Therefore, descriptions above with reference to FIGS. 1 to 3 and 8 may be included in descriptions of FIG. 9.

The vibration apparatus 581 according to another embodiment may substantially a same as any one of the vibration apparatuses 200, 300, and 400 described above with reference to FIGS. 4 to 8, and thus, the repetitive description thereof may be omitted. Therefore, descriptions above with reference to FIGS. 4 to 8 may be included in descriptions of FIG. 9.

The display apparatus 500 according to the first embodiment of the present disclosure may output one of the sound, the directional sound, the vibration haptic, the texture haptic, and the ultrasonic haptic, or may simultaneously output two or three of them, based on the display panel 510 (or cover window 530) by vibration of the one or more vibration generating apparatuses 580, and thus, when haptic is driven, haptic feedback of various textures may be provided to the user, and the user's recognition (or perception) characteristic of the vibration haptic and/or the texture haptic may be improved.

FIG. 10 is a cross-sectional view illustrating a display apparatus according to a second embodiment of the present disclosure.

Referring to FIG. 10, the display apparatus 600 according to a second embodiment of the present disclosure may include a display panel 610 and one or more vibration generating apparatuses 680.

The display panel 610 may be configured to display an image. For example, the display panel 610 may be configured to display one or more of a moving image, a still image, and a plurality of vehicle control icons. For example, the display panel 610 may include a light emitting display or a light emitting diode display. For example, the display panel 610 may be an organic light emitting display panel.

The display panel 610 according to an embodiment may include a base substrate 611, a pixel array part 613 disposed (or configured) on the base substrate 611, and an encapsulation part 615 disposed (or configured) on the pixel array part 613.

The base substrate 611 may be made of a plastic material, but is not limited thereto.

The pixel array part 613 may include a plurality of pixels configured to display an image based on signals supplied to pixel signal lines configured (or formed) at a first surface of the base substrate 611.

Each of the plurality of pixels may include a pixel circuit layer including a driving thin film transistor which is provided at a pixel area configured by a plurality of gate lines and/or a plurality of data lines, an anode electrode electrically connected to the driving thin film transistor, a light emitting device layer formed on the anode electrode, and a cathode electrode electrically connected to the light emitting device layer.

The light emitting device layer may be implemented to emit a same color of light (for example, white) for each pixel, or may be implemented to emit different colors of light (for example, red, green, or blue) for each pixel.

The encapsulation part 615 may be configured to directly surround the pixel array part 613. The encapsulation part 615 may be configured to prevent external moisture or humidity from penetrating toward the light emitting device layer. The encapsulation part 615 may be formed of an inorganic material layer or an organic material layer, or formed as a multilayer structure in which inorganic and organic material layers are alternately stacked. For example, the encapsulation part 615 may be omitted based on the structure of the display panel 610.

The display apparatus 600 according to the second embodiment of the present disclosure may further include a cover window 630.

The cover window 630 may be configured to cover a front surface of the display panel 610. For example, the cover window 630 may be attached to the front surface of the display panel 610 by using a first transparent adhesive member 620. For example, the cover window 630 may protect the display panel 610 from external impact or block impacts applied to the display panel 610. For example, the cover window 630 may be made of a transparent plastic material or a glass material, but is not limited thereto.

The display panel 610 according to an embodiment may be configured to display an image based on a top emission scheme, but is not limited thereto. For example, the display panel 610 may be configured to display an image based on a bottom emission scheme. For example, light generated in pixels based on the top emission scheme may pass through the encapsulation part 615 and may be emitted toward a front direction of the cover window 630. In the bottom emission scheme, the base substrate 611 may be coupled to the cover window 630 and may configure (or form) the front surface of the display panel 610. Accordingly, light generated in pixels based on the bottom emission scheme may pass through the base substrate 611 and may be emitted toward a front direction of the cover window 630.

The display apparatus 600 according to the second embodiment of the present disclosure may further include a touch panel 650 disposed on the encapsulation part 615. An optical film may be disposed between the touch panel 650 and the cover window 630.

The touch panel 650 according to an embodiment may be disposed (or interposed) between the cover window 630 and the display panel 610 and configured to sense a user touch on the cover window 630. As an example, the touch panel 650 may include a touch electrode layer including a plurality of touch driving lines and a plurality of touch sensing lines based on a mutual capacitance scheme. As another example, the touch panel 650 may include a touch electrode layer including a plurality of touch electrodes based on a self-capacitance scheme.

The touch panel 650 may be attached to a front surface of the display panel 610 by using a second transparent adhesive member 640 and coupled to the cover window 630 by a first transparent adhesive member 620. For example, the cover window 630 may be attached to a front surface of the touch panel 650 by using the first transparent adhesive member 620.

The touch panel 650 according to another embodiment may be directly formed on the encapsulation part 615 based on an in-cell touch scheme. For example, when the light emitting device layer has a top emission scheme, the touch panel 650 may be changed to a touch electrode layer directly formed at a front surface of the encapsulation part 615. As an example, the touch electrode layer may include a plurality of touch driving lines and a plurality of touch sensing lines based on a mutual capacitance scheme. As another example, the touch electrode layer may include a plurality of touch electrodes based on a self-capacitance scheme.

The display apparatus 600 according to the second embodiment of the present disclosure may further include a back plate 660 attached to a rear surface of the display panel 610.

The back plate 660 may be attached to a second surface opposite to a first surface of the base substrate 611. The back plate 660 may be attached to the second surface opposite to the first surface of the base substrate 611 by using an adhesive layer. The back plate 660 may increase the rigidity of the display panel 610 and dissipate heat generated from the display panel 610. For example, the back plate 660 may be made of a metal material.

The one or more vibration generating apparatuses 680 may be configured to vibrate the display panel 610. The one or more vibration generating apparatuses 680 may be attached to the rear surface of the display panel 610. The one or more vibration generating apparatuses 680 may be attached to the rear surface of the display panel 610 by using a coupling member 690. For example, the one or more vibration generating apparatuses 680 may be attached to a rear surface of the back plate 660 by using the coupling member 690.

The one or more vibration generating apparatuses 680 may vibrate the display panel 610 to output one of a sound, a directional sound, a vibration haptic, a texture haptic, and an ultrasonic haptic, or to simultaneously output two or three of them. For example, the display panel 610 may be used as a vibration member (or a vibration plate or a sound plate) that vibrates based on the driving (or vibration or displacement) of the one or more vibration generating apparatuses 680 to generate (or output) a sound and/or a vibration.

The one or more vibration generating apparatuses 680 may include a vibration apparatus 681.

The vibration apparatus 681 according to an embodiment may substantially a same as the vibration apparatus 100 described above with reference to FIGS. 1 to 3, and thus, the repetitive description thereof may be omitted. Therefore, descriptions above with reference to FIGS. 1 to 3 and 8 may be included in descriptions of FIG. 10.

The vibration apparatus 681 according to another embodiment may substantially a same as any one of the vibration apparatuses 200, 300, and 400 described above with reference to FIGS. 4 to 8, and thus, the repetitive description thereof may be omitted. Therefore, descriptions above with reference to FIGS. 4 to 8 may be included in descriptions of FIG. 10.

The display apparatus 500 according to the second embodiment of the present disclosure may output one of the sound, the directional sound, the vibration haptic, the texture haptic, and the ultrasonic haptic, or may simultaneously output two or three of them, based on the display panel 610 (or cover window 630) by vibration of the one or more vibration generating apparatuses 680, and thus, when haptic is driven, haptic feedback of various textures may be provided to the user, and the user's recognition (or perception) characteristic of the vibration haptic and/or the texture haptic may be improved.

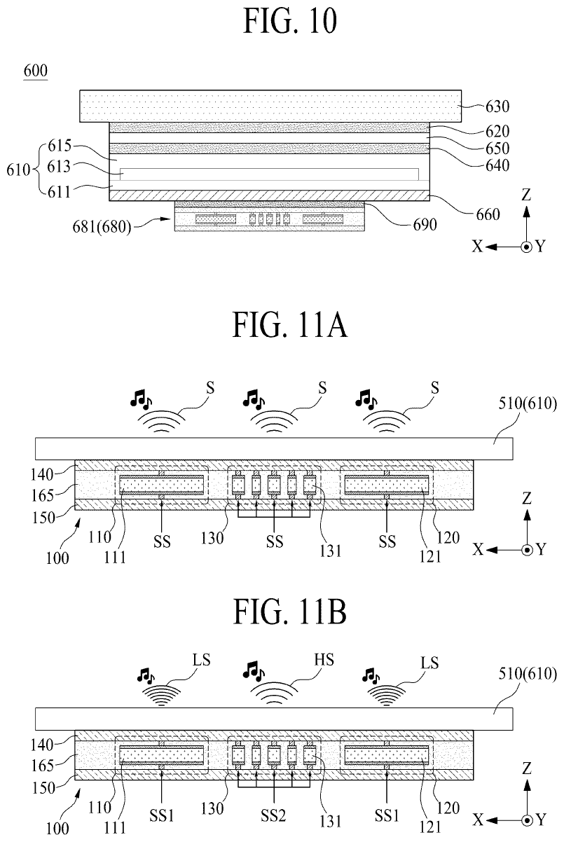

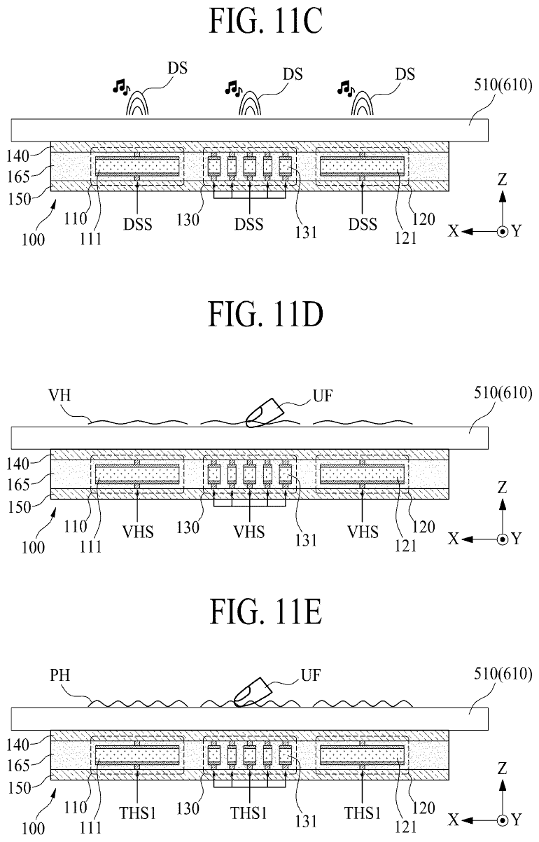

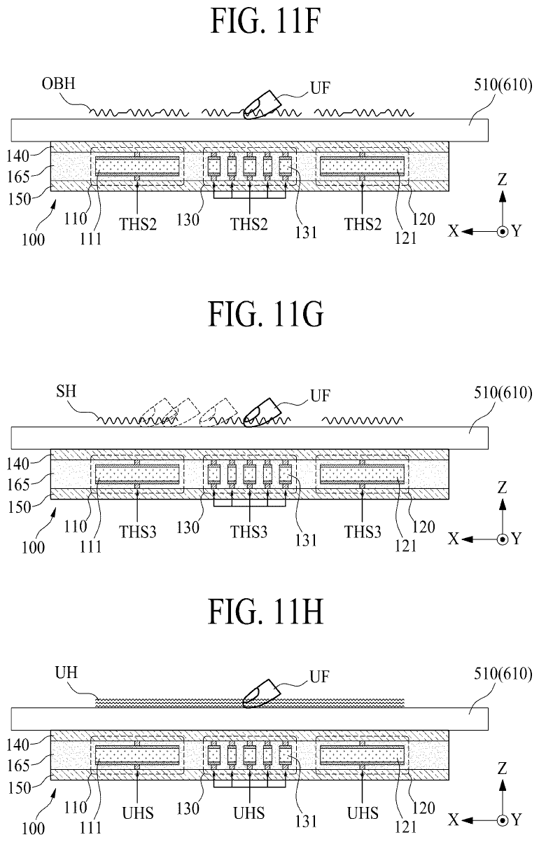

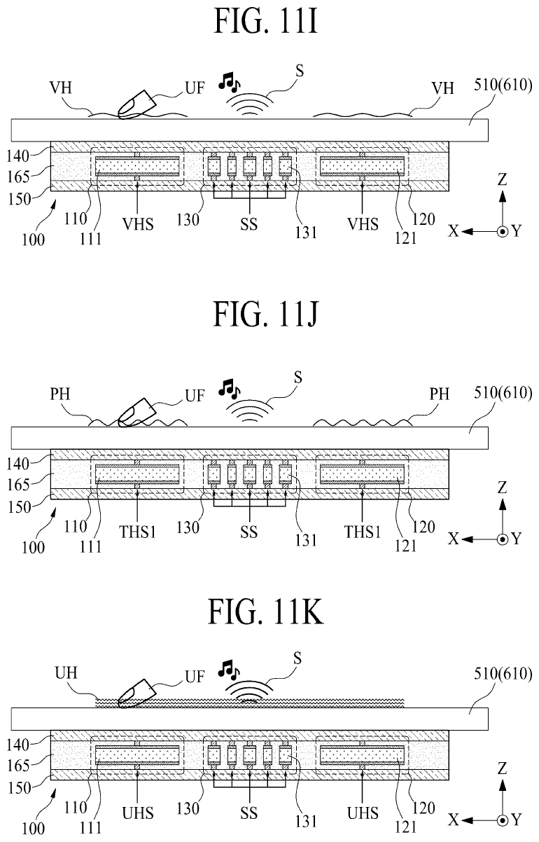

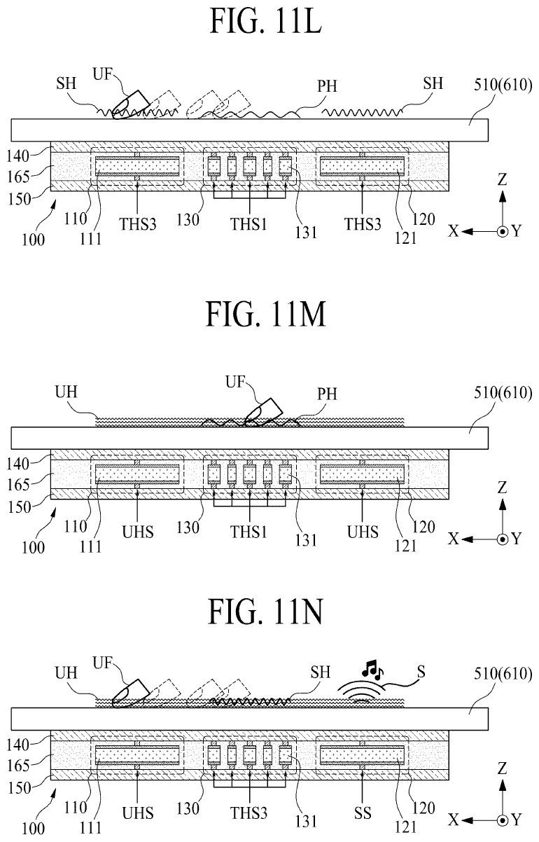

FIGS. 11A to 11N are diagrams illustrating a sound output and a haptic output of the display apparatus according to the first and second embodiments of the present disclosure illustrated in FIGS. 9 and 10.

Referring to FIGS. 1 and 11A, in the display apparatus according to the first and second embodiments of the present disclosure, each of the first to third vibration parts 110, 120, and 130 of the vibration apparatus 100 according to an embodiment may vibrate (or drive or displace) according to a same sound signal SS supplied from the vibration driving circuit 180. Accordingly, display panel 510 and 610 may vibrate based on the vibration of each of the first to third vibration parts 110, 120, and 130 to output a same sound S. For example, the sound S generated (or output) based on vibration of display panel 510 may have a frequency band of 50 Hz to 20 kHz, but is not limited thereto.

Referring to FIGS. 1 and 11B, in the display apparatus according to the first and second embodiments of the present disclosure, each of the first and second vibration parts 110 and 120 of the vibration apparatus 100 according to another embodiment may vibrate according to a sound signal SS1 of a low-pitched sound band supplied from the vibration driving circuit 180, and the third vibration part 130 of the vibration apparatus 100 may vibrate based on a sound signal SS2 of a middle-high-pitched sound band supplied from the vibration driving circuit 180. Accordingly, the display panel 510 and 610 may output sound LS of the low-pitched sound band at portions corresponding to each of the first and second vibration parts 110 and 120, and may output a sound HS of the high-pitched sound band at a portion corresponding to the third vibration part 130.

Referring to FIGS. 1 and 11C, in the display apparatus according to the first and second embodiments of the present disclosure, each of the first to third vibration parts 110, 120, and 130 of the vibration apparatus 100 according to another embodiment may vibrate according to a same directional sound signal DSS supplied from the vibration driving circuit 180. Accordingly, the display panel 510 and 610 may vibrate based on the vibration of each of the first to third vibration parts 110, 120, and 130 to output a directional sound DS. For example, the sound DS generated based on vibration of display panel 510 and 610 may have a frequency band of 50 Hz to 20 kHz, but is not limited thereto.

Referring to FIGS. 1 and 11D, in the display apparatus according to the first and second embodiments of the present disclosure, each of the first to third vibration parts 110, 120, and 130 of the vibration apparatus 100 according to another embodiment may vibrate according to a same vibration haptic signal VHS supplied from the vibration driving circuit 180 based on user's touch (or short touch or one touch). Thus, the display panel 510 and 610 may vibrate based on the vibration of each of the first to third vibration parts 110, 120, and 130 to output a vibration haptic VH. Accordingly, when the user touches, the user may recognize the vibration haptic VH generated based on the vibration of display panel 510 and 610 through finger UF.

Referring to FIGS. 1 and 11E, in the display apparatus according to the first and second embodiments of the present disclosure, each of the first to third vibration parts 110, 120, and 130 of the vibration apparatus 100 according to another embodiment may vibrate according to a same push haptic signal THS1 supplied from the vibration driving circuit 180 based on user's push touch. Thus, the display panel 510 and 610 may vibrate based on the vibration of each of the first to third vibration parts 110, 120, and 130 to output a push haptic PH. Accordingly, when the user push touches, the user may recognize a texture haptic corresponding to the push haptic PH generated based on the vibration of display panel 510 and 610 through finger UF.

Referring to FIGS. 1 and 11F, in the display apparatus according to the first and second embodiments of the present disclosure, each of the first to third vibration parts 110, 120, and 130 of the vibration apparatus 100 according to another embodiment may vibrate according to a same option box haptic signal THS2 supplied from the vibration driving circuit 180 based on user's long touch (or option box touch). Thus, the display panel 510 and 610 may vibrate based on the vibration of each of the first to third vibration parts 110, 120, and 130 to output an option box haptic OBH. Accordingly, when the user long (or option box) touches, the user may recognize a texture haptic corresponding to the option box haptic OBH generated based on the vibration of display panel 510 and 610 through finger UF.

Referring to FIGS. 1 and 11G, in the display apparatus according to the first and second embodiments of the present disclosure, each of the first to third vibration parts 110, 120, and 130 of the vibration apparatus 100 according to another embodiment may vibrate according to a same slide haptic signal THS3 supplied from the vibration driving circuit 180 based on user's slide touch. Thus, the display panel 510 and 610 may vibrate based on the vibration of each of the first to third vibration parts 110, 120, and 130 to output a slide haptic SH. Accordingly, when the user slide touches, the user may recognize a texture haptic corresponding to the slide haptic SH generated based on the vibration of display panel 510 and 610 through finger UF.

Referring to FIGS. 1 and 11H, in the display apparatus according to the first and second embodiments of the present disclosure, each of the first to third vibration parts 110, 120, and 130 of the vibration apparatus 100 according to another embodiment may vibrate according to a same ultrasonic haptic signal UHS supplied from the vibration driving circuit 180 based on user's touch. Thus, the display panel 510 and 610 may output an ultrasonic (or an ultrasonic wave) based on the vibration of each of the first to third vibration parts 110, 120, and 130. At this time, the ultrasonic may generate squeeze film effect to provide an ultrasonic haptic to user's finger UF. The squeeze film effect may be referred to as surface ultrasonic lubrication, and the surface ultrasonic lubrication may change a friction coefficient (or a frictional force) between the user's finger UF and the display panel 510 and 610 through changing of a friction coefficient of a surface of the display panel 510 and 610 to implement fine texture or roughness recognizable by the user. Accordingly, when the user touches, the user may recognize a texture haptic corresponding to the ultrasonic haptic UH generated based on the vibration of the display panel 510 and 610 through finger UF.

Referring to FIGS. 1 and 11I, in the display apparatus according to the first and second embodiments of the present disclosure, each of the first and second vibration parts 110 and 120 of the vibration apparatus 100 according to another embodiment may vibrate according to a same vibration haptic signal VHS supplied from the vibration driving circuit 180 based on user's touch (or short touch or one touch), and the third vibration part 130 of the vibration apparatus 100 may vibrate according to a sound signal SS supplied from the vibration driving circuit 180. Thus, the display panel 510 and 610 may output a vibration haptic VH at portions corresponding to each of the first and second vibration parts 110 and 120, and a sound S at a portion corresponding to the third vibration part 130. Accordingly, when the user touches, the user may recognize the vibration haptic VH generated based on the vibration of the display panel 510 and 610 through finger UF.

Referring to FIGS. 1 and 11J, in the display apparatus according to the first and second embodiments of the present disclosure, each of the first and second vibration parts 110 and 120 of the vibration apparatus 100 according to another embodiment may vibrate according to a same push haptic signal THS1 supplied from the vibration driving circuit 180 based on the user's push touch, and the third vibration part 130 of the vibration apparatus 100 may vibrate according to a sound signal SS supplied from the vibration driving circuit 180. Thus, the display panel 510 and 610 may output a push haptic PH at portions corresponding to each of the first and second vibration parts 110 and 120, and may output a sound S at a portion corresponding to the third vibration part 130. Accordingly, when the user touches, the user may recognize a texture haptics corresponding to the push haptic PH generated based on the vibration of the display panel 510 and 610 through finger UF.

According to another embodiment, each of the first and second vibration parts 110 and 120 of the vibration apparatus 100 may vibrate according to a same option box haptic signal (or a slide haptic signal) supplied from the vibration driving circuit 180 based on the user's option box haptic (or the user's slide haptic), and in this case, when the user touches, the user may recognize a texture haptic corresponding to the option box haptic (or the slide haptic) generated based on the vibration of the display panel 510 and 610 through the finger UF.

Referring to FIGS. 1 and 11K, in the display apparatus according to the first and second embodiments of the present disclosure, each of the first and second vibration parts 110 and 120 of the vibration apparatus 100 according to another embodiment may vibrate according to a same ultrasonic haptic signal UHS supplied from the vibration driving circuit 180 based on the user's touch, and the third vibration part 130 of the vibration apparatus 100 may vibrate according to a sound signal SS supplied from the vibration driving circuit 180. Thus, the display panel 510 and 610 may output an ultrasonic haptic UH based on the vibration of each of the first and second vibration parts 110 and 120, and may output a sound S at a portion corresponding to the third vibration part 130. Accordingly, when the user touches, the user may recognize a texture haptic corresponding to the ultrasonic haptic UH generated based on the vibration of the display panel 510 and 610 through finger UF.

Referring to FIGS. 1 and 11L, in the display apparatus according to the first and second embodiments of the present disclosure, each of the first and second vibration parts 110 and 120 of the vibration apparatus 100 according to another embodiment may vibrate according to a same slide haptic signal THS3 supplied from the vibration driving circuit 180 based on the user's slide touch, and the third vibration part 130 of the vibration apparatus 100 may vibrate according to a push haptic signal THS1 supplied from the vibration driving circuit 180 based on the user's push touch. Thus, the display panel 510 and 610 may output a slide haptic SH at portions corresponding to each of the first and second vibration parts 110 and 120, and may output a push haptic PH at a portion corresponding to the third vibration part 130. Accordingly, when the user slide touches, the user may simultaneously recognize two texture haptics corresponding to the push haptic PH and the slide haptic SH generated based on the vibration of the display panel 510 and 610 through finger UF.

Referring to FIGS. 1 and 11M, in the display apparatus according to the first and second embodiments of the present disclosure, each of the first and second vibration parts 110 and 120 of the vibration apparatus 100 according to another embodiment may vibrate according to a same ultrasonic haptic signal UHS supplied from the vibration driving circuit 180 based on the user's touch, and the third vibration part 130 of the vibration apparatus 100 may vibrate according to a push haptic signal THS1 supplied from the vibration driving circuit 180 based on the user's push touch. Thus, the display panel 510 and 610 may output an ultrasonic haptic UH based on the vibration of each of the first and second vibration parts 110 and 120, and may output a push haptic PH at a portion corresponding to the third vibration part 130. Accordingly, when the user push touches, the user may simultaneously recognize two texture haptics corresponding to the push haptic PH and the ultrasonic haptic UH generated based on the vibration of the display panel 510 and 610 through finger UF.

Referring to FIGS. 1 and 11N, in the display apparatus according to the first and second embodiments of the present disclosure, the first vibration part 110 of the vibration apparatus 100 according to another embodiment may vibrate according to an ultrasonic haptic signal UHS supplied from the vibration driving circuit 180 based on the user's touch, the second vibration part 120 of the vibration apparatus 100 may vibrate according to a sound signal SS supplied from the vibration driving circuit 180, and the third vibration part 130 of the vibration apparatus 100 may vibrate according to a slide haptic signal THS3 supplied from the vibration driving circuit 180 based on the user's slide touch. Thus, the display panel 510 and 610 may output an ultrasonic haptic UH based on the vibration of the first vibration part 110, may output a sound S at a portion corresponding to the second vibration part 120, and may output a slide haptic SH at a portion corresponding to the third vibration part 130. Accordingly, when the user slide touches, the user may simultaneously recognize two texture haptics corresponding to the slide haptic SH and the ultrasonic haptic UH generated based on the vibration of the display panel 510 and 610 through finger UF.

The vibration apparatus 100 described above with reference to FIGS. 11A to 11N may be changed to any one of the vibration apparatus 200, 300, and 400 described above with reference to FIGS. 4 to 7, and thus, the repetitive description thereof may be omitted.

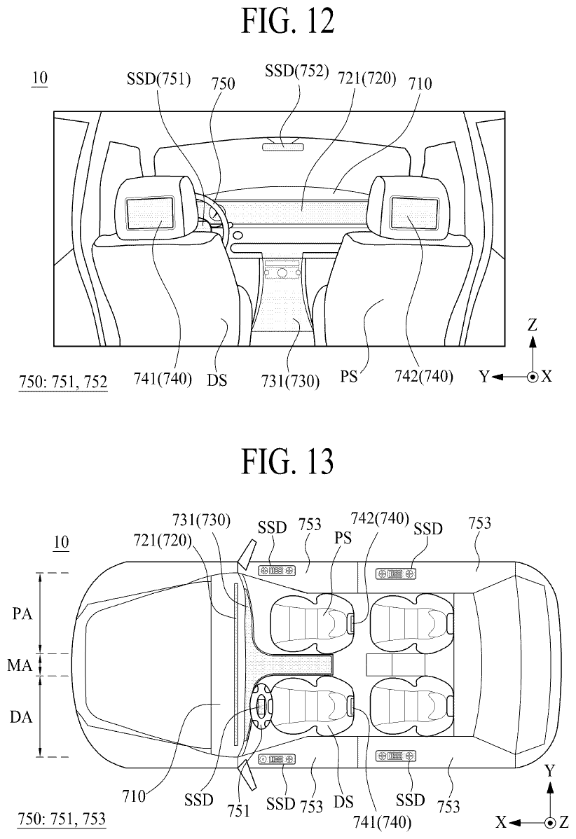

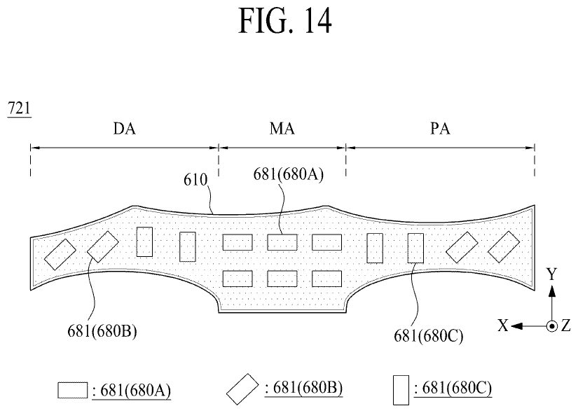

FIG. 12 is a diagram illustrating a vehicular apparatus according to an embodiment of the present disclosure. FIG. 13 is a plan view illustrating a vehicular apparatus according to an embodiment of the present disclosure. FIG. 14 is a diagram illustrating a first display illustrated in FIGS. 12 and 13.

Referring to FIGS. 12 and 13, a vehicular apparatus 10 according to an embodiment of the present disclosure may include one or more seats DS and PS and one or more windows. For example, the vehicular apparatus 10 may include a vehicle, a train, a ship, or an aircraft, or the like.

The vehicular apparatus 10 according to an embodiment of the present disclosure may include a dashboard 710, an instrument panel module 720, a central control module 730, and an infotainment module 740.

The dashboard 710 may include a first region DA facing a driver seat DS, a second region PA facing a passenger seat PS, and a third region MA between the first region DA and the second region PA.

The instrument panel module 720 may include a first display (or main display) 721 disposed at the first region DA of the dashboard 710.

The first display 721 may provide a driver with various information such as vehicle state information and driving-related information such as the driving time, velocity, fuel amount, and revolutions per minute (RPM) of the vehicle. In addition, the first display 721 may be connected to a navigation system and a vehicle convenience system such as an audio system, an air conditioning system, and a multimedia system, or the like equipped inside the vehicle and may display navigation information provided from the navigation system and control icons for controlling a corresponding vehicle convenience system.

The first display 721 may have a size corresponding to the first region DA of the dashboard 710, but is not limited thereto. For example, the first display 721 may have a length extended from the first region DA of the dashboard 710 into the third region MA or the second region PA. For example, the first display 721 disposed at the first region DA of the dashboard 710 may be disposed across the third region MA and the second region PA.

The first display 721 according to an embodiment may include a square shape or a rectangular shape. For example, the first display 721 may include a square shape or a rectangular shape having a long-side length extended from the first region DA of the dashboard 710 into the third region MA or the second region PA.

The first display 721 includes the display apparatus 500 and 600 described above with reference to FIG. 9 or 10, and thus, the repetitive description thereof may be omitted. Accordingly, the first display 721 may display an image, corresponding to vehicle driving information provided from a vehicle host system, on the display panel. In addition, the first display 721 may output one or more of a sound, a directional sound, a vibration haptic, a texture haptic, and an ultrasonic haptic based on the vibration of the vibration apparatus. For example, the first display 721 may output one of the sound, the directional sound, the vibration haptic, the texture haptic, and the ultrasonic haptic, or may simultaneously output two or three of them.

Referring to FIGS. 13 and 14, the first display 721 according to another embodiment may include a display panel 610 and one or more (or a plurality of) vibration generating apparatuses 680A, 680B, and 680C.

The display panel 610 may include a non-rectangular shape having one or more curved surfaces. For example, the first display 610 may have a length extended from the first region DA of the dashboard 710 into the third region MA or the second region PA, and include one or more straight portions, one or more oblique portions, and one or more curved portions. Except for that the display panel 610 may have a non-rectangular shape, the display panel 610 may the same as the display panel 610 of the display apparatus 600 described above with reference to FIG. 10, and thus, like reference numerals refer to like elements and the repetitive description thereof may be omitted. Therefore, descriptions above with reference to FIG. 10 may be included in descriptions of FIG. 14.

According to an embodiment, the one or more vibration generating apparatuses 680A, 680B, and 680C may be coupled to a rear surface of the display panel 610. For example, the first display 721 according to another embodiment may include one or more first vibration generating apparatuses 680A, one or more second vibration generating apparatuses 680B, and one or more third vibration generating apparatuses 680C.

According to an embodiment, the one or more first vibration generating apparatuses 680A may be coupled to a rear middle area of the display panel 610 corresponding to the third region MA of the dashboard 710, but is not limited thereto. The one or more second vibration generating apparatuses 680B may be coupled to each of rear edge portions of the display panel 610 corresponding to an edge portion of each of the first region DA and the second region PA of the dashboard 710, but is not limited thereto. The one or more third vibration generating apparatuses 680C may be coupled to the rear surface of the display panel 610 corresponding to one side area of each of the first region DA and the second region PA adjacent to the third region MA of the dashboard 710, but is not limited thereto. For example, the arrangement positions of each of the one or more first vibration generating apparatuses 680A, the one or more second vibration generating apparatuses 680B, and the one or more third vibration generating apparatuses 680C may be variously changed according to a sound output characteristic of the first display 610.

According to an embodiment, the one or more first vibration generating apparatuses 680A, the one or more second vibration generating apparatuses 680B, and the one or more third vibration generating apparatuses 680C may be disposed in a same direction or different directions from each other. For example, a long-side length direction of the one or more first vibration generating apparatuses 680A, the one or more second vibration generating apparatuses 680B, and the one or more third vibration generating apparatuses 680C may be disposed in different directions from each other or intersect with each other.

Each of the one or more first vibration generating apparatuses 680A, the one or more second vibration generating apparatuses 680B, and the one or more third vibration generating apparatuses 680C may include a vibration apparatus 681.

The vibration apparatus 681 according to an embodiment may substantially the same as the vibration apparatus 100 described above with reference to FIGS. 1 to 3 and 8, and thus, the repetitive description thereof may be omitted. Therefore, descriptions above with reference to FIGS. 1 to 3 and 8 may be included in descriptions of FIG. 14.

The vibration apparatus 681 according to another embodiment may substantially the same as the vibration apparatuses 200, 300, and 400 described above with reference to FIGS. 4 to 7, and thus, the repetitive description thereof may be omitted. Therefore, descriptions above with reference to FIGS. 4 to 7 may be included in descriptions of FIG. 14.

According to an embodiment, the vibration apparatus 681 of the one or more first vibration generating apparatuses 680A may the same as the vibration apparatus 100 described above with reference to FIGS. 1 to 3 and 8, the vibration apparatus 681 of the one or more second vibration generating apparatuses 680B may the same as the vibration apparatuses 200, 300, and 400 described above with reference to any one of FIGS. 4 to 7, and the vibration apparatus 681 of the one or more third vibration generating apparatuses 680C may the same as the vibration apparatuses 200, 300, and 400 described above with reference to any one of FIGS. 4 to 7, but is not limited thereto.

The first display 721 according to another embodiment may further include a cover window and a touch panel described above with reference to FIG. 10, and thus, the repetitive description thereof may be omitted.

Referring to FIGS. 12 and 13, the central control module (or a center fascia module) 730 may include a second display 731 extending from the third region MA of the dashboard 710 into a space (or region) between the driver seat DS and the passenger seat PS. For example, the central control module 730 may have a “T” shape.

The second display 731 may be connected to a vehicle convenience system such as an audio system, an air conditioning system, and a multimedia system, or the like equipped inside the vehicle and may display vehicle control icons (or user interface icons) for controlling a corresponding vehicle convenience system. In addition, the second display 731 may output one or more of a sound, a directional sound, a vibration haptic, a texture haptic, and an ultrasonic haptic based on the vibration of the vibration apparatus. For example, the second display 731 may output one of the sound, the directional sound, the vibration haptic, the texture haptic, and the ultrasonic haptic, or may simultaneously output two or three of them.

Except for that the second display 731 may have the “T” shape, the second display 731 may the same as the display apparatus described above with reference to FIG. 9 or 10, and thus, the repetitive description thereof may be omitted. For example, in the display apparatus described above with reference to FIG. 9 or 10, the vibration apparatus may include one or more first vibration apparatuses 100, one or more second vibration apparatuses 200, and one or more third vibration apparatuses 300 which are coupled to be spaced apart from each other at the rear surface of the display panel 510 and 610, and thus, the repetitive description thereof may be omitted.

The second display 731 may further include a cover window and touch panel described above with reference to FIG. 9 or 10, and thus, the repetitive description thereof may be omitted.

The infotainment module 740 may include a third display 741 disposed at a rear surface of the driver seat (or a driver's seat) DS, and a fourth display 742 disposed at a rear surface of the passenger seat (or a passenger's seat) PS.

The third display 741 may be disposed or embedded in a headrest of the driver seat DS, and the fourth display 742 may be disposed or embedded in a headrest of the passenger seat PS.

Each of the third and fourth displays 741 and 742 may the same as the display apparatus described above with reference to FIG. 10, and thus, like reference numerals refer to like elements and the repetitive description thereof may be omitted. Each of the third and fourth displays 741 and 742 may further include a cover window and a touch panel described above with reference to FIG. 10, and thus, the repetitive description thereof may be omitted.

In the vehicular apparatus 10 according to an embodiment of the present disclosure, one or more of the first to fourth displays 721, 731, 741, and 742 may include a display panel configured to display an image, and one or more vibration generating apparatuses attached to a rear surface of the display panel, and the one or more vibration generating apparatuses may include the vibration apparatus described above with reference to FIGS. 1 to 11N.

The vehicular apparatus 10 according to an embodiment of the present disclosure may further include a vehicle interior material 750 and a smart surface display SSD disposed at the vehicle interior material 750.

The vehicle interior material 750 may include a steering wheel 751 installed at the first region DA of the dashboard 710, a room mirror 752 installed at a roof panel over the second region MA of the dashboard 710, and a door interior material 753 installed to cover a door frame.

The smart surface display SSD may be disposed at one or more of the steering wheel 751, the room mirror 752, and the door interior material 753.

The smart surface display SSD may be configured to display an image. For example, the smart surface display SSD may be configured to display a plurality of vehicle control icons (or user interface icons) including one or more of an image, a character, a shape, a sign, a symbol, and a number.

The smart surface display SSD may be configured to output one of a sound, a directional sound, a vibration haptic, a texture haptic, and an ultrasonic haptic, or to simultaneously output two or three of them. The smart surface display SSD may the same as the display apparatus described above with reference to FIG. 9, and thus, like reference numerals refer to like elements and the repetitive description thereof may be omitted. For example, one or more of the smart surface displays SSD may include a display panel configured to display an image and one or more vibration generating apparatuses attached to a rear surface of the display panel, and the one or more vibration generating apparatuses may include the vibration apparatus described above with reference to FIGS. 1 to 11N. One or more of the smart surface displays SSD may further include a cover window and a touch panel described above with reference to FIG. 9, and thus, the repetitive description thereof may be omitted.

The vehicular apparatus 10 according to an embodiment of the present disclosure may output one or more of the sound, the directional sound, the vibration haptic, the texture haptic, and the ultrasonic haptic through the displays 721, 731, 741, 742, and SSD, or may simultaneously output two or three of them, and when haptic is driven, haptic feedback of various textures may be provided to the user, and the user's recognition (or perception) characteristic of the vibration haptic and/or the texture haptic may be improved.

It will be apparent to those skilled in the art that various modifications and variations can be made in the present disclosure without departing from the spirit or scope of the disclosures. Thus, it is intended that the present disclosure covers the modifications and variations of the present disclosure provided that within the scope of the claims and their equivalents.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A vibration apparatus, comprising:
first to n-th vibration parts disposed parallel to each other where n is a natural number greater than or equal to 3;
a first cover member covering a first surface of each of the first to n-th vibration parts;
a second cover member covering a second surface opposite to the first surface of each of the first to n-th vibration parts; and
an adhesive member disposed between the first cover member and the second cover member and surrounding side surfaces of each of the first to n-th vibration parts,
wherein each of the first to n-th vibration parts comprises any one shape of a circular plate shape, an oval plate shape, and a polygonal plate shape.

2. The vibration apparatus of claim 1, wherein:
one or more of the first to n-th vibration parts have a different size relative to remaining ones of the first to n-th vibration parts, and
each of the first to n-th vibration parts is configured to output any one of a sound, a directional sound, a vibration haptic, and an ultrasonic haptic.

3. The vibration apparatus of claim 2, further comprising:
a vibration driving circuit configured to supply a vibration driving signal to each of the first to n-th vibration parts,
wherein the vibration driving signal supplied to each of the first to n-th vibration parts comprises any one of a sound signal corresponding to the sound, a directional sound signal corresponding to the directional sound, a vibration haptic signal corresponding to the vibration haptic, and an ultrasonic haptic signal corresponding to the ultrasonic haptic.

4. The vibration apparatus of claim 3, wherein:
the vibration haptic comprises any one of a push haptic corresponding to a push touch, an option box haptic corresponding to a relatively longer touch than the push touch, and a slide haptic corresponding to a slide touch, and
the vibration haptic signal comprises any one of a push haptic signal corresponding to the push touch, an option box haptic signal corresponding to the relatively longer touch, and a slide haptic signal corresponding to the slide touch.

5. The vibration apparatus of claim 1, wherein:
the first cover member comprises a first area, a second area parallel to the first area, and a third area between the first area and the second area,
n is equal to 3,
the first vibration part is disposed between the first cover member and the second cover member corresponding to the first area,
the second vibration part is disposed between the first cover member and the second cover member corresponding to the second area, and
the third vibration part is disposed between the first cover member and the second cover member corresponding to the third area.

6. The vibration apparatus of claim 5, wherein:
the first vibration part comprises one or more first vibration devices,
the second vibration part comprises one or more second vibration devices, and
the third vibration part comprises one or more third vibration devices.

7. The vibration apparatus of claim 6, wherein each of the one or more first vibration devices, the one or more second vibration devices, and the one or more third vibration devices comprises:
a vibration layer including a piezoelectric material;
a first electrode layer at a first surface of the vibration layer; and
a second electrode layer at a second surface different from the first surface of the vibration layer.

8. The vibration apparatus of claim 5, wherein:
the first vibration part comprises one first vibration device having the circular plate shape,
the second vibration part comprises one second vibration device having the circular plate shape,
the third vibration part comprises a plurality of third vibration devices having a triangular plate shape, and
the plurality of third vibration devices are spaced apart from each other along one or more directions of a first direction and a second direction intersecting the first direction.

9. The vibration apparatus of claim 8, wherein:
the plurality of third vibration devices have a same size, and
a total size of the plurality of third vibration devices is smaller than a size of each of the one first vibration device and the one second vibration device.

10. The vibration apparatus of claim 8, wherein the plurality of third vibration devices are disposed in the oval plate shape or to a polygonal shape having 2M sides in a plan view where M is a natural number greater than or equal to 2.

11. The vibration apparatus of claim 5, wherein:
the first vibration part comprises one first vibration device having a rectangular shape or a square shape,
the second vibration part comprises one second vibration device having a rectangular shape or a square shape,
the third vibration part comprises a plurality of third vibration devices having a triangular plate shape, and
the one first vibration device has a same shape as the one second vibration device.

12. The vibration apparatus of claim 11, wherein the plurality of third vibration devices are disposed in the oval plate shape or in a polygonal shape having 2M sides in a plan view where M is a natural number greater than or equal to 2.

13. The vibration apparatus of claim 5, wherein:
the first vibration part comprises one first vibration device having a rectangular shape or a square shape,
the second vibration part comprises a plurality of second vibration devices having a triangular plate shape, and
the third vibration part comprises one third vibration device having the circular plate shape.

14. A display apparatus, comprising:
a display panel configured to display an image; and
one or more vibration generating apparatuses attached to a rear surface of the display panel,
wherein the one or more vibration generating apparatuses comprise the vibration apparatus of claim 1.

15. The display apparatus of claim 14, further comprising:
a cover window covering a front surface of the display panel, and
a touch panel disposed between the cover window and the display panel and sensing a user touch on the cover window.

16. The display apparatus of claim 14, further comprising a cover window covering a front surface of the display panel,
wherein the display panel comprises:
a base substrate;
a pixel array part disposed on the base substrate;
an encapsulation part covering the pixel array part;
a touch panel disposed on the encapsulation part; and
an optical film disposed between the touch panel and the cover window.

17. A vehicular apparatus, comprising:
a dashboard including a first region facing a driver seat, a second region facing a passenger seat, and a third region between the first region and the second region;
an instrument panel module including a first display disposed at the dashboard;
a central control module including a second display extending from the third region of the dashboard into a space between the driver seat and the passenger seat; and
an infotainment module including at least one of a third display disposed at a rear surface of the driver seat and a fourth display disposed at a rear surface of the passenger seat,
wherein one or more of the first to fourth displays comprises:
a display panel configured to display an image; and
one or more vibration generating apparatuses attached to a rear surface of the display panel,
wherein the one or more vibration generating apparatuses comprise the vibration apparatus of claim 1.

18. The vehicular apparatus of claim 17, wherein:
one or more of the first to fourth displays further comprises:
a cover window covering a front surface of the display panel; and
a touch panel disposed between the cover window and the display panel and configured to sense a user touch on the cover window, and
the display panel has a non-rectangular shape including one or more curved surfaces.

19. A vehicular apparatus, comprising:
a vehicle interior including a steering wheel, a rear view mirror, and a door interior panel;
a dashboard including a first region facing a driver seat, a second region facing a passenger seat, and a third region between the first region and the second region;
an instrument panel module including a main display extending from the first region of the dashboard into the third region or the second region;
a central control module including a second display extending from the third region of the dashboard into a space between the driver seat and the passenger seat; and
a smart surface display disposed at one or more of the steering wheel, the rear view mirror, and the door interior panel,
wherein one or more of the main display and the smart surface display comprises:
a display panel configured to display an image; and
one or more vibration generating apparatuses attached to a rear surface of the display panel,
wherein the one or more vibration generating apparatuses comprise the vibration apparatus of claim 1.

20. The vehicular apparatus of claim 19, wherein:
one or more of the main display and the smart surface display further comprises:
a cover window covering a front surface of the display panel; and
a touch panel disposed between the cover window and the display panel and sensing a user touch on the cover window, and
the display panel has a non-rectangular shape including one or more curved surfaces.
